(19) United States
(12) Patent Application Publication
(10) Pub. No.: US 2015/0027504 A1
(43) Pub. Date: Jan. 29, 2015

(54) SANITIZING APPARATUS AND SYSTEM FOR HOME BREWING EQUIPMENT

(71) Applicant: Mark Milroy, Tigard, OR (US)

(72) Inventor: Mark Milroy, Tigard, OR (US)

(21) Appl. No.: 14/341,705

(22) Filed: Jul. 25, 2014

Related U.S. Application Data
(60) Provisional application No. 61/858,401, filed on Jul. 25, 2013.

(51) Int. Cl. B08B 9/08; F16M 11/04; F16M 11/22; B08B 9/093

(52) U.S. Cl. CPC B08B 9/0826; B08B 9/093; F16M 11/04; F16M 11/22
USPC 134/169 R; 134/166 R; 248/346.03

(57) ABSTRACT

A basin can contain a cleaning solution and a support assembly configured to support one or more containers of the type commonly used during home brewing of beverages. An adapter can mount to the basin and a plurality of nozzles can extend through an aperture defined by the adapter. One or more inverted containers can overlie a respective nozzle. A retainer in the carriage frame can receive one or more inverted or upright containers, and a nozzle can eject a stream of wash solution into an inverted container. The adapter can direct residual wash solution drained from the inverted container to the basin.

### RELATED APPLICATIONS

This application claims the benefit of and priority to U.S. Provisional Application Ser. No. 61/858,401, filed Jul. 25, 2013, the contents of which is hereby incorporated by reference as if recited in full herein for all purposes.

The innovations disclosed herein pertain, in part but not exclusively, to the technologies disclosed in U.S. Patent Application No. 61/300,399, filed on Feb. 1, 2010, and U.S. patent application Ser. No. 13/018,782, filed on Feb. 1, 2011. The entire disclosure of each of the aforementioned patent applications is hereby incorporated by reference as if set forth herein in its respective entirety, for all purposes.

### BACKGROUND

The inventive subject matter disclosed herein relates to an apparatus and system for sanitizing home brewing equipment and containers such as, by way of example, bottles and tubing. In particular, but not exclusively, the innovations pertain to apparatus, systems, and methods for conveniently cleaning one or more containers, for example, bottles, kegs and other devices associated with the home brewing of fermented beverages.

Any number of beverages can be, and are, frequently brewed in a home or other amateur setting. Examples of such beverages include beer, wine, cider, mead, ginger ale, sake, etc. Many successful home brewers and professional brewers rely on sanitation as a key to their success. For example, making beer consists of growing yeast in a medium very favorable to micro-organisms, such as malted barley. Contamination by other microorganisms must be strictly guarded against to ensure successful and repeatable outcomes. Brewing beer often involves using large containers and long hoses. Before the beer is clarified, the solution in the container and tubes can have sediments of inactive yeast and other residues. Such items can be particularly difficult to clean and sterilize. Currently, common cleaning approaches involve chemicals and chlorine bleach to sterilize these items.

For storing home brewed beer, kegging is sometimes recommended over storing in individual bottles. Kegs can be more convenient to clean and store than individual bottles, and carbonation levels can be easily adjusted in larger kegs. By far the most common system used by home brewers for draft beer is the 5-gallon soda canister, originally manufactured by the Cornelius Company (Annoka, Minn.). Though other companies also make similar models, the style is usually referred to as a Cornelius or “Corny” keg. These stainless steel canisters were developed and used to distribute premixed soda for common restaurant dispensers. The keg shape, capacity, and fittings are standardized, and over the years millions have been manufactured. Most of the component parts of Corny kegs will contact the beer, so it is extremely important that all parts be properly cleaned and sanitized before use.

Another example of a container that is often used in home brewing is a carboy. It is a glass or plastic vessel used in fermenting beverages. The carboy is a rigid container with a typical capacity of 5 to 15 gallon (19 to 57 Liter). Carboys are used for transporting fluids such as water, chemicals, etc. They are also used for in-home fermentation of beverages, often wine. In brewing, a carboy is also known as a demijohn. Usually it is fitted with a rubber stopper and a fermentation lock to prevent bacteria and oxygen from entering during the fermentation process. Polypropylene carboys are also commonly used in laboratories to transfer purified water. They are typically filled at the top and have a spigot at the bottom for dispensing.

Yet another example of a container often used in home brewing is a bottle. Such bottles are typically vessels formed of plastic or glass and in which fermentation occurs. Commonly, bottles have a fluid capacity of about 12 ounces, about 22 ounces, or about 40 ounces. Such bottles are often capped (e.g., with a press-on cap or a screw cap), though some bottles are corked or capped using a cap and mechanical linkage system configured to urge the cap downward toward the mouth of the bottle when the linkage system in positioned in a closed configuration.

Cleaning of these containers usually involves a tedious process of soaking, rotating, brushing, and rinsing. Some prior art cleaning equipment attaches to a faucet and allows for a nozzle to be inserted in the keg. For example, a commercially available Spray Wand sold by Homebrewers Outpost (http://www.homebrewers.com/product/4794/Spray_Wand.html). This system does not give the option of spraying the cleaning solution into the bottle and it is unwieldy to use.

Some other keg washers use a submersible pump that is positioned in a bucket. However, these keg washers do not allow direct access by the user to the cleaning solution during use and do not accommodate different sizes of containers in a single design. Moreover, these keg washers include a tubing assembly that is positioned in the bucket where it becomes submerged or drenched with fluid.

Other attempts at bottle washing have been made, as indicated in FIG. 25. In FIG. 25, a carrier can receive twelve inverted bottles and a linear, manifolded array of twelve nozzles can be inserted into the bottles while the carrier is held over the nozzles by a user. However, such a bottle washer is messy and the bottles, once washed, usually need to be moved to another container for storage. Moreover, at least six positions in the carrier will be empty if one desires to wash thirty bottles, increasing the likelihood of making a large mess with the depicted washer.

None of the existing cleaning systems provides the easy of operation, efficiency, and versatility of the inventive subject matter.

Accordingly there is a need for an apparatus and a system that makes it convenient to sanitize home brewing vessels and tubes. In addition, there remains a need for a convenient and sterile place to temporarily store other items used in the home brewing process.

### SUMMARY

The inventive subject matter overcomes problems in the prior art by providing a system, apparatus, and method for sanitizing home brewing equipment with one or more of the following qualities, alone or in combination.

In one possible embodiment, the inventive subject matter is directed to a sanitizing system for home brewing equipment, including a basin for holding a cleaning solution (sometimes referred to as a “wash solution”), a support assembly mountable in the basin, the support assembly sized and configured to support a container in an upside down position and above the cleaning solution, a plumbing assembly having at least one drain channel coupled to the basin to receive cleaning solution from the basin and at least one pressurizable channel configured to extend into the body of the container. The plumbing assembly may further have a pump interacting with the channels so that when the pump is activated pressurized cleaning solution is released from the pressurizable channel inside the container against the inner walls of the container so that the inside of the container is sanitized and the cleaning solution drains back into the basin. In the foregoing embodiment, the plumbing assembly may further have a channel branching off the pressurizable channel and adapted for cleaning home brewing accessories, such as tubes. In the foregoing embodiment, the support assembly may have a bracket adapted for supporting a bottle type container upside down by supporting the shoulders of the bottle and holding the mouth of the bottle above the cleaning solution. In the foregoing embodiment, the plumbing assembly may have at least one valve for regulating the flow of the cleaning solution through the plumbing assembly. In the foregoing embodiment, the basin may be used for storing home brewing equipment, with or without the presence of cleaning solution. In the foregoing embodiment, the support assembly may be adapted to support a container having a volume ranging between 3 and 15 gallons, for example a carboy or Cornelius keg as used for home brewing.

In another possible embodiment, the inventive subject matter is directed to an apparatus for sanitizing home brewing equipment. The apparatus may have a basin for holding a cleaning solution, a support assembly mounted in the basin and having dimensions adapted for supporting a bottle type container with the shoulders of the container resting on the support assembly and adapted to hold the container with the mouth of the container downward and above the cleaning solution, a drain channel having a first end and a second end, the first end coupled to the basin so that cleaning solution drains from the basin into the drain channel, a pump being coupled to a second end of the drain channel, a pressurizable channel having one end coupled to the pump, and a free end provided with a spray nozzle, the free end and nozzle sized to be inserted into the container. The pump pressurizes the cleaning solution into the pressurizable channel and the pressurizable channel releases the cleaning solution under pressure via the nozzle into the container so that the inside of the container is sanitized and the cleaning solution drains back into the basin. In the foregoing embodiment, the basin may be provided with legs supporting the basin and wherein the drain channel, pump, and pressurizable channel are positioned below the bottom of the basin and the pressurizable channel extends through the bottom of the basin to reach the inside of the container. In the foregoing embodiment, the pressurizable channel may branch off with a channel adapted to clean tubes used in home brewing equipment. In the foregoing embodiment, the plumbing assembly may have at least one valve for regulating the flow of the cleaning solution through the plumbing assembly.

In yet another possible embodiment, the inventive subject matter is directed to a method for cleaning home brewing equipment, the method including providing a basin with a cleaning solution, positioning a container in an upside down position and above the cleaning solution, providing a pump for pressurizing cleaning solution into a channel configured to extend into the body of the container so that when the pump is activated pressurized cleaning solution is released from the pressurizable channel against the inner walls of the container thereby sanitizing the inside of the container. Cleaning solution drains back into the basin. The basin is configured to allow direct access by the user to the cleaning solution during use of the basin while the pump is activated, and wherein the basin has support elements defining footprints for supporting at least two different sizes of containers, and wherein one footprint is within the perimeter of the other footprint. In the foregoing embodiment, the method may include providing for a support assembly that is adapted to support a container having a volume ranging between approximately 3 and 15 gallons, such as a carboy or Cornelius keg as used in home brewing.

In another possible embodiment, a basin for sanitizing containers may have a chamber to hold a solution, a raised platform sized and configured to support a container in an upside down position above the solution, the platform housing a submersible pump so that, when the pump is activated, solution enters the pump from the chamber and pressurized solution is released from the pump into a channel extending into the container so that the inside of the container will be sanitized and solution drains back into the chamber of the basin via a container opening. The chamber may be configured to allow direct access by the user to the solution during use of the basin, and the basin includes support elements defining footprints for supporting at least two different sizes of containers, and wherein one footprint is within the perimeter of the other footprint. In the foregoing embodiment, one footprint may be concentric to the other footprint. In the foregoing embodiment, the footprints may be concentric to a pump outlet channel. In the foregoing embodiment, the support elements may define a first footprint having a diameter for supporting a larger size container and within the perimeter of the first footprint support elements that define a second footprint having a diameter for supporting smaller sized containers. In the foregoing embodiment, the basin may have a first footprint for supporting different sizes of containers and further comprises a second footprint within the perimeter of the first footprint for supporting bottle type containers. In the foregoing embodiment, support elements may be configured, for example, to support a standard 7 gallon brew pail with a 14″ diameter opening and 16″ high and/or a standard 5 gallon pail with a 12″ opening and 14″ high.

The inventive subject matter further contemplates a system for sanitizing containers having a basin including an open chamber for holding a solution, a raised platform sized and configured to support a container in an upside down position and above the solution, the platform housing a submersible pump so that, when the pump is activated, solution enters the pump from the chamber and pressurized solution will be released from the pump into the container so that he inside of the container will be sanitized and solution drains back into the chamber of the basin via a container opening. The chamber may be configured to allow direct access by the user to the solution during use of the basin, and the basin includes support elements defining a first footprint for supporting at least two different sizes of containers. The system further includes a support assembly mountable within the perimeter of the first footprint, the support assembly comprising a second footprint defined by support elements for supporting a bottle type container in an upside down position and above the solution. Pressurized solution will be released from the pump into to a pressurizable channel configured to extend into the body of the container. In the foregoing embodiment, the first and second footprints may be adapted to support container having a volume ranging between 3 and 15 gallons.

The inventive subject matter also contemplates a kit including a basin, for example as described above, a support assembly, and a pressurizable channel. Some kits may also include a submersible pump.

These and other embodiments are described in more detail in the following detailed descriptions and the figures.

The foregoing is not intended to be an exhaustive list of embodiments and features of the inventive subject matter. Persons skilled in the art are capable of appreciating other embodiments and features from the following detailed description in conjunction with the drawings.

### BRIEF DESCRIPTION OF THE DRAWINGS

The following figures show embodiments according to the inventive subject matter, unless noted as showing prior art.

FIG. 1 is a sketch of a perspective view of an apparatus for sanitizing home brewing equipment.

FIG. 2 is a schematic representation of a system for sanitizing home brewing equipment.

FIG. 3 is a schematic representation of another system for sanitizing home brewing equipment.

FIG. 4 is a perspective view of a basin with a pump.

FIG. 5 is a perspective view of a basin, pump, and support rack.

FIG. 6 is another perspective view of the embodiment of FIG. 5.

FIG. 7 shows an isometric view of one example of an assembly of components forming a bottle management system of the type disclosed herein.

FIG. 8 shows the assembly shown in FIG. 7 with opposed side walls of a carriage frame removed to reveal internal components of the management system.

FIG. 9 shows the assembly shown in FIG. 8 with opposed end walls of the carriage frame removed.

FIG. 10 shows the assembly shown in FIG. 9, with the upper and the lower receivers removed to reveal additional aspects of a retainer.

FIG. 11 shows the assembly shown in FIG. 10 with several inverted bottles removed.

FIG. 12 shows the assembly shown in FIG. 11 with the retainer removed to reveal additional aspects of the adapter, the distribution manifold and a nozzle.

FIG. 13A shows the assembly shown in FIG. 12 with several inverted bottles added.

FIG. 13B shows the distribution manifold together with nozzle corresponding to each outlet from the manifold.

FIG. 14 shows the assembly shown in FIG. 13 with the inverted bottles and the adapter removed.

FIG. 15 shows the assembly shown in FIG. 14 with the nozzle and an upper panel of the distribution manifold removed to reveal internal aspects of the distribution manifold.

FIG. 16 shows the assembly shown in FIG. 15 with the lower panel of the distribution manifold removed to reveal an isometric view of the basin and pump assembly shown in FIG. 4.

FIG. 17 shows an isometric view from above a portion of the bottle management system shown in FIG. 7 and reveals a substantial vertical alignment among the outlet ports of the distribution manifold and bottle receiver apertures.

FIG. 18 shows an isometric view of a portion of the bottle management system, as well as aspects of the adapter configured to operatively align the adapter with the wash basin shown in FIGS. 16 and 4.

FIG. 19 shows a mating engagement between an arcuate ridge defined by a lower surface of the adapter and a portion of the basin.

FIG. 20 shows an engagement of a leg extending from a lower surface of the adapter and the basin.

FIG. 21 shows an isometric view of the basin shown in FIGS. 4 and 16.

FIG. 22 shows an alternative configuration of a bottle management system of the type described herein. The alternative configuration pertains to the receiver configuration.

FIG. 23 shows another alternative configuration of a bottle management system of the type described herein. The illustrated bottle management system includes an alternatively configured carriage frame and retainer.

FIG. 24 shows the alternatively configured carriage frame and retainer

FIG. 25 shows another arrangement of a bottle management system.

FIGS. 26 through 28 show particular aspects of the bottle management system shown in FIG. 25.

### DETAILED DESCRIPTION

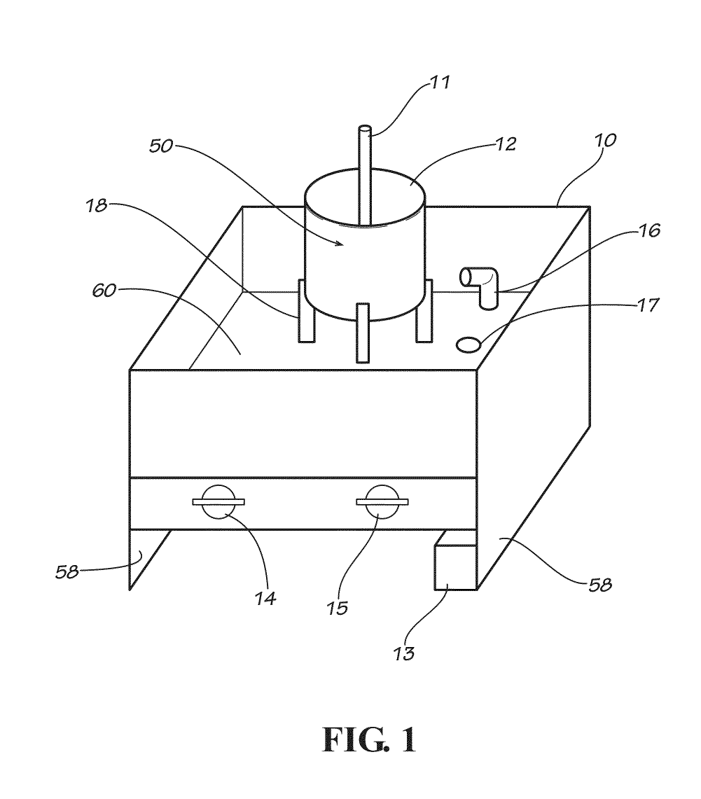

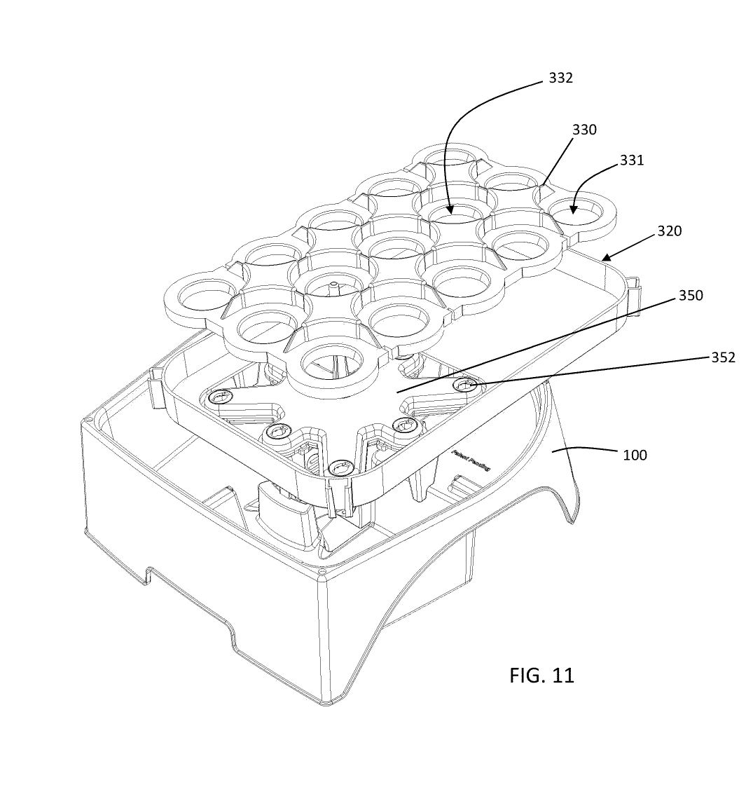

Representative embodiments according to the inventive subject matter are shown in FIGS. 1-28, wherein the same or generally similar features share common reference markers, e.g., numerals.

The inventive subject matter is directed to a system and apparatus for sanitizing home brewing equipment. The system includes a basin for holding a cleaning solution, a support assembly mountable in the basin, the support assembly sized and configured to support a container in an upside down position with its opening above the cleaning solution, and a pressurizable channel extending from a pump into the container. The “upside down” position of a container refers to a position wherein the opening of the container faces the basin. In some embodiments, the system may include a plumbing assembly having at least one drain channel coupled to the basin to receive cleaning solution from the basin and at least one pressurizable channel configured to extend into the body of the container. The plumbing assembly may further include a pump interacting with the channels so that, when the pump is activated, pressurized cleaning solution is released from the pressurizable channel inside the container against the inner walls of the container so that the inner walls of the container are sanitized and the cleaning solution drains back into the basin. Optionally, the system may further include one or more channel(s) branching off the pressurizable channel and adapted for cleaning home brewing accessories, such as tubes or connector pieces. Additionally, the system may integrate support mechanisms for at least two different sizes of containers to be supported in a single basin. For example, the basin may have support elements defining footprints for supporting at least two different sizes of containers. One footprint may be within the perimeter of the other footprint. These support elements may be adapted to support containers, such as a 7 gallon brew pail, 5 gallon container, or carboy. These containers do not fit in a regular dishwasher and may be easily sanitized by the systems according to the inventive subject matter. The figures illustrate how the system and apparatus may be used, for example, for cleaning kegs, carboys, brew pails, tubes and miscellaneous brewing items. In contrast to existing keg washing systems, the open basin design of the inventive subject matter allows easy access to the cleaning fluid while the keg washer is in use.

As used herein the term “container” refers to a rigid container for holding fluid, such as a pail or bottle. The container could be cylindrical, rectangular, or any other shape. In the case of a bottle shaped container, the container has a neck that is narrower than the body of the bottle, and a mouth at the end of the neck. Containers may be made of glass, clay, plastic, aluminum or other impervious materials, and are typically used to store liquids such as water, milk, soft drinks, beer, wine, cooking oil, medicine, shampoo, ink and chemicals.

The terms “tube” and “channel” refer to a hollow, usually cylindrical body of metal, glass, rubber, or other material, used for conveying or containing liquids or gases.

The term “plumbing assembly” refers to a system for conveying cleaning solution, water, etc., for example by channels, tubes, or pipes. The plumbing assembly may further include a pump.

The term “basin” refers to an open, shallow container such as used for holding liquids.

FIGS. 1-3 show a system and apparatus for cleaning the inside of a home brewing beverage container. The apparatus includes a basin 10, a drain channel 25, a pump 13, and a pressurizable channel 26. A support assembly 50 is mounted in basin 10 for supporting a container, such as bottle 20 with the mouth 54 of the bottle facing downward. Basin 10 is filled with a cleaning solution 30 up to water line 21. Bottle 20 is positioned on the support so that mouth 54 remains above water line 21. When pump 13 is activated, cleaning solution 30 is drawn from basin 10 through drain channel 25 to the pump 13 where it is pressurized and sent through pressurizable channel 26 up to first tube 40 ending in nozzle 11. Nozzle 11 ejects the pressurized cleaning solution in the container so that the cleaning solution is distributed over the inner walls or an inside surface area 52 of the container. The cleaning solution drips down towards neck 56 and mouth 54 of bottle 20, thereby cleaning the inside surface 52 of bottle 20, and drips back into basin 10.

As shown in FIGS. 1-3, basin 10 is a rectangular tub elevated above a horizontal surface with legs 58 to allow room for plumbing assembly 32 below the basin bottom 60. The basin may be made out of any material suitable for holding a cleaning solution, for example stainless steel, plastic, etc. Basin 10 is filled with a cleaning solution up to a certain level marked by water line 21 so that the system is allowed to function. The amount of cleaning solution required for optimal performance will vary with the size of the system.

Support assembly 50 is mounted on basin 10 and is adapted to support an inverted container 20 with the container opening 254 above water line 21. The location of support assembly 50 allows cleaning solution 30 to drain back into basin 10. In the embodiment shown in FIG. 1, support assembly 50 is formed by a bracket 12 positioned in the center of the basin 10 with three legs 18 mounted on the bottom of basin 10. Bracket 12 may be concentric around tube 40 and may hold container 20, such as a carboy or a Cornelius keg upside down so that nozzle 11 is positioned internally to container 20. In other possible embodiments, brackets may be clipped to the sides of the basin for supporting a brew pail, for example. The support assembly is sized to support containers or bottles as they are commonly used in home brewing. The volume of containers used in home brewing typically ranges between 3 and 15 gallons. A common volume of a homebrewed batch of beer is typically around 5 gallons. However, the support assembly may be adapted to hold any size of container used in a home brewing process.

Basin 10 is provided with a drain 17 allowing cleaning solution to drain out of the basin. Drain 17 may be located at any suitable location in basin 10 where the drain does not interfere with the functioning of the system. For example, drain 17 may be a circular opening in the bottom 60 of basin 10 so that the cleaning solution gravitates into drain channel 25. Optionally, drain 17 may be provided with a closing mechanism or a filter. In some possible embodiment, the bottom of basin 10 may be sloped towards the drain opening to facilitate draining of the cleaning solution.

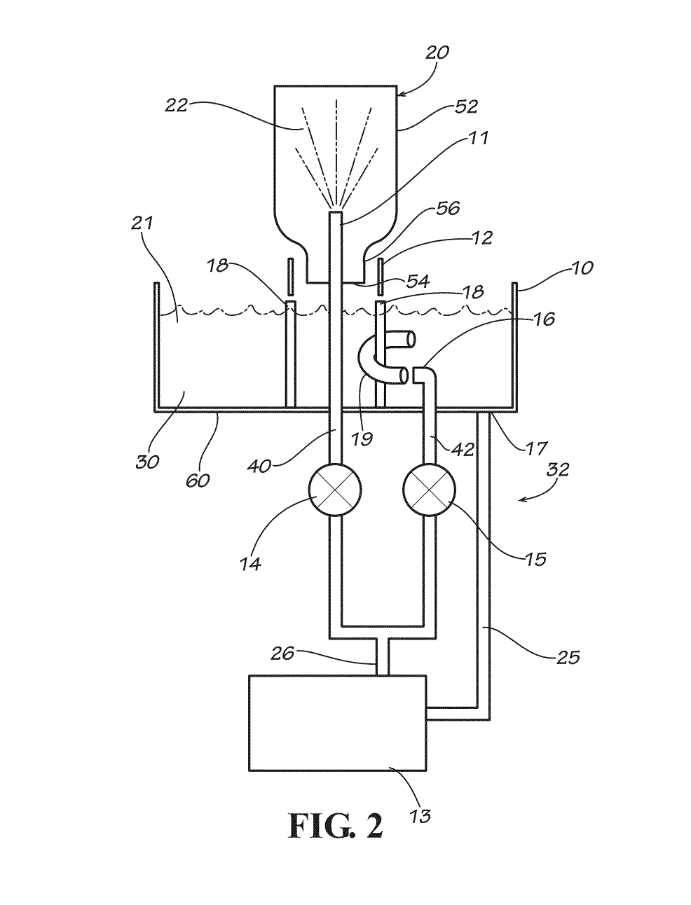

Drain channel 25 and pressurizable channel 26 may be formed by any type of suitable tubing material, for example, food grade flexible plastic tubes that are not affected by the cleaning solution. Drain channel 25 and pressurizable channel 26 are part of a plumbing assembly 32. Plumbing assembly 32 may further include one or more branches of tubes or channels depending on the embodiment. For example, as shown in FIGS. 1 and 2, pressurizable channel 26 leads to a first tube 40 extending through basin 10 upward above water line 21 into container 20. Channel 26 may also lead to a second tube 42 that extends into basin 10 and that is adapted for cleaning brewing accessories, for example brew tube 19. Tube 42 may end below waterline 21 in a tube washing barb 16 that releases pressurizable cleaning solution and facilitates coupling to brew tube 19, for example.

Plumbing assembly 32 further includes a pump 13 that interacts with channels 25 and 26. Pump 13 may be any type of commercially available pump that provides the desired amount of pressure and that is safe for handling food. For example, a magnetic drive pump may be used. These pumps require no seals or lubricants for operation and only plastic parts come in contact with the fluid. For example, a 700 gallon per minute drive pump that is submersible may be used in the system described above.

Cleaning solution is drawn from the basin 10 through a drain 17 to pump 13. Pressurized cleaning solution is directed via channel 26 and tube 40 to nozzle 11 and/or to tube barb 16. The flow to nozzle 11 is controlled by valve 14. The flow to the tube barb 16 is controlled by a valve 15.

Examples of suitable cleaning solutions are chlorinated water or water and automatic dishwasher soap. However, regular water or any other suitable sanitizing solution or cleaning agent may be used. The process may be repeated with different cleaning solutions in different steps. For example, in a first step a keg, its lid, and a siphon hose may be cleaned with chlorinated water. In a second step, soap may be used as a cleaning solution for cleaning brewing accessories.

FIG. 2 illustrates the relative positions of the bracket, nozzle and bottle of one embodiment of the system. Support 18 positions bracket 12 above water line 21. A beverage container, such as bottle 20, for example a carboy, is positioned in bracket 12 so that nozzle 11 is positioned in about the center of the inside of bottle 20 and the bottle is cleaned by the cleaning solution, for example chlorinated spray 22, emanating from the nozzle 11. The cleaning solution drips from the inside of the carboy through bracket 12 into basin 10.

The system and apparatus may further be used to clean tubes associated with home brewing. For example, a tube 19 may be attached manually to tube barb 16. When the system is activated, pressurized cleaning solution arrives from tube barb 16 into tube 19 thereby cleaning the inside of tube 19. Additionally, when submerging tube 19 in the cleaning solution, the outside of tube 19 will also be sanitized.

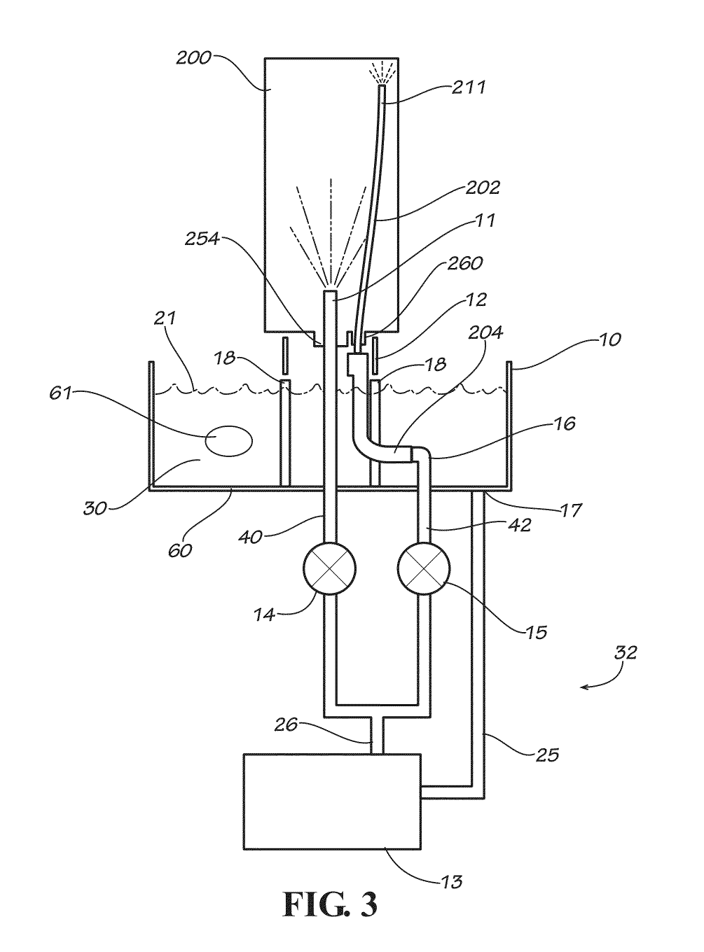

In another possible embodiment, the system and apparatus may be used to sanitize a Cornelius keg. Typically, an assembled Cornelius keg has at least one valve connected to an inner tube or pipe leading into the keg. The valve and inner tube are used to pressurize the fluid inside the Cornelius keg. The Cornelius keg further has an opening that is located next to the valve and that is covered with a top plate. The top plated is sealed with an O-ring. A handle usually presses the top plate against the O-ring and keg. When the keg is disassembled, the top plate is removed from the opening in the keg. FIG. 3 shows a Cornelius keg 200 as it is placed upside down on bracket 12 allowing tube 40 to extend into the body of the keg 200 through keg opening 254 and allowing the shoulders of keg 200 to rest on bracket 12. Top plate 61 of keg 200 may be stored submerged in cleaning solution 30 in basin 10. Keg 200 further has a valve 260 connected to inner tube 202. In addition to the sanitation provided by the use of tube 40 as described above, keg 200 and inner tube 202 may be sanitized by connecting valve 260 to the system. Valve 260 may be connected to an extension tube of tube barb 16, for example by using an extension tube 204 as is commonly used in the home brewing process. Tube 204 has one end coupled to tube barb 16 and another end coupled to valve 260. When the system is activated, pressurized cleaning solution is sent through valve 260 into inner tube 202 thereby cleaning valve 260 and the inside of inner tube 202. Cleaning solution may emanate from the end 211 of inner tube 202 and provide additional cleaning solution to the inside of keg 200. The system may be activated, for example, by switching pump 13 on and opening valve 15 thereby pumping cleaning solution from basin 10 through tube 42 into inner tube 202. Additionally, valve 14 may be opened to clean the inside of keg 200 as described above. The cleaning solution will drain back into basin 10 through keg opening 254.

In the embodiments shown in FIGS. 1-3, the dimensions of the basin are approximately 15.5″ by 15.5″ at the base and the sides are approximately 16″ high. Bracket 12 is approximately 5″ in diameter and 4″ high. The base of bracket 12 is mounted on three legs 18 which suspend the bottom of the bracket at a level approximate to the level of the top of the basin. The nozzle protrudes approximately 8″ beyond the upper rim of the bracket. In the embodiment illustrated in FIG. 2, water line 21 comes to within an inch of the top of the basin 10. In one possible embodiment, a vertical tube with a spray nozzle attachment protrudes 13″ above the water line of the basin. The tube is positioned in the middle of the basin. These dimensions are for illustrative purposes only and the dimensions and overall size of the apparatus may vary.

In some embodiments, basin 10 may be adapted to support larger containers in an upside down position. Some large containers, for example buckets, do not have shoulders and bottle neck. These types of containers may be supported in the basin by hooks or brackets hanging from the sides of the basin and supporting the rims of the bucket above the cleaning solution. For example, in the embodiments shown in FIGS. 1-3 four hooks may be attached to the outer rim on each side of the basin to accommodate brew pails.

In some possible embodiments, plumbing assembly 32 may include a valve for regulating the flow of cleaning solution 30. Both nozzle 11 and the tube barb 16 may be controlled by manually operated valves, for example valves 14 and 15. In other embodiments, additional operating mechanisms may be added.

Optionally, basin 10 may be used to store other accoutrements used in brewing such as funnels, bubblers, thermometers, strainers, etc. These items may be submerged in the basin to maintain sterility until needed. The basin may also be used, without cleaning solution, for drying and storing these items.

In some embodiments such as for home brewing beer, the sanitizing method may be used to first sterilize a keg, its lid, and a siphon hose. Subsequently, beer may be transferred from a carboy into the sanitized keg. The used carboy and brewing equipment could then be cleaned in a second cleaning step. After cleaning the carboy, the basin may be emptied and the equipment allowed to dry.

The inventive subject matter further contemplates a basin for sanitizing home brewing equipment and a system for using such a basin. In this embodiment, a submersible pump is positioned directly in the cleaning solution in the basin instead of below the basin, as described in the embodiments above, thereby eliminating the need for connecting tubes and regulating valves. The basin may be formed as a one-piece structure, for example, as a one-piece molded design. Such a one-piece structure is easy to sanitize, lightweight, and does not leak. Moreover, such a basin is easy to assemble/disassemble because few additional parts are needed to use the keg washer.

The basin includes an open chamber to hold a solution and a raised platform sized and configured to support a container in an upside down position above the solution. Additionally, the basin can be used to sanitize anything that touches the beer such as vessels, hoses, strainers, thermometers, etc.

The basin has a footprint of support elements adapted to support at least two different sizes of containers. For example, the shape of the basin may be curved along the platform on one side of the basin to complement the shape of a brew pail, such as a large 7 gallon pail. To hold the pail in position during use, the basin may have a curved rim extending along the platform. Furthermore, the platform may have additional support elements protruding from the rim along the platform and concentric with the outer support elements to accommodate smaller sizes of pails. Additional support elements may be positioned in the chamber or extending from the sides of the chamber. In some embodiments, the basin may be shaped to complement a brew pail on all sides. In other embodiments, the overall diameter of the basin may be reduced to clean smaller containers, such as a carboy. In some embodiments, the support elements define footprints that are concentric with one another.

The platform is further configured to accommodate a pump. For example, the platform may have a cutout to house a submersible pump so that, when the pump is activated, solution enters the pump from the chamber and pressurized solution is released from the pump into the container. A pump outlet channel may be positioned centrally to the support elements.

Cleaning solution that exits the container drains back into the basin. In some embodiments, the platform may be slanted towards the chamber of the basin so that cleaning solution flows into the basin. In other embodiments, the entire basin may be positioned at an angle with the chamber at the lowest point. Optionally, support elements may be configured to hold the container in a suitable position.

In some embodiments, the chamber of the basin is dimensioned to allow a user access to the solution during the cleaning process, for example to remove/add solution or the add substances to the solution.

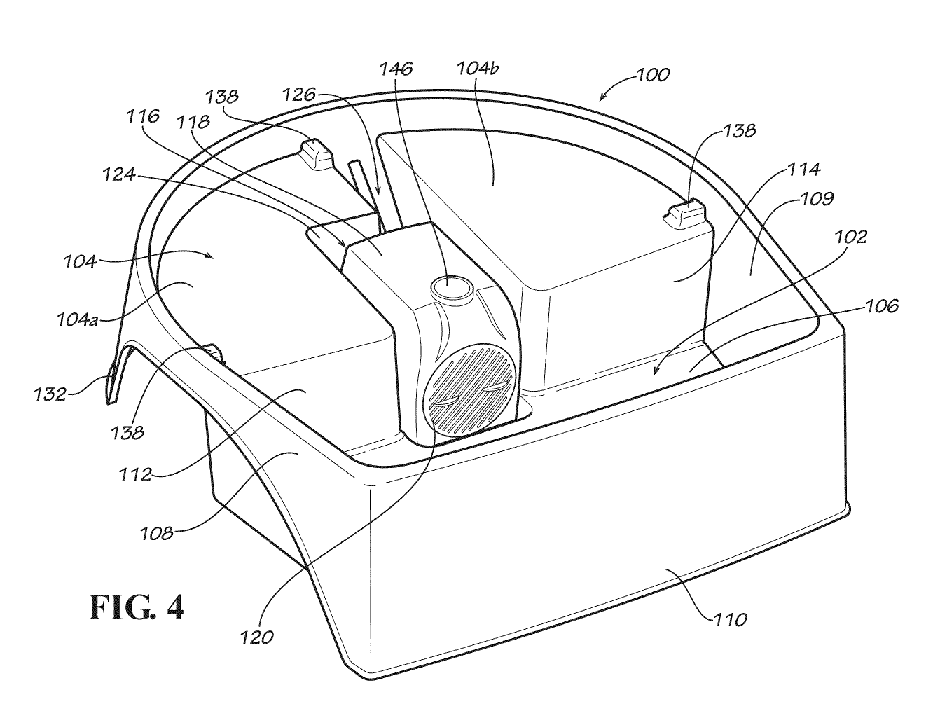

FIG. 4 shows a basin 100 with a chamber 102 and a platform 104. Chamber 102 is formed as an open area having a bottom surface 106 and sidewalls 108, 109, 110, 112 and 114. Three of the four sides of the chamber are formed by outer side walls 108, 109, and 110 of basin 100. A fourth side wall of the chamber is formed by walls 112 and 114 extending upward from bottom surface 106 to platform 104. Between wall 112 and 114 a cutout 116 in platform 104 houses a pump 118. Cutout 116 splits platform 104 in two portions 104a and 104b. Pump 118 is positioned in cutout 116 so that the intake side 120 of pump 118 faces chamber 102 and complements walls 112 and 114 to form a fourth side wall of chamber 102. Pump outlet channel 146 may be positioned centrally in basin 100. Cutout 116 is shaped to complement pump 118 so that the pump is hugged securely along its sides during use. Additionally, bottom surface 106 may be recessed below pump 118 to prevent pump 118 from moving forward into chamber 102 during use. Backward movement of pump 118 may be prevented by wall 124 of cutout 116 which faces backside 122 of pump 118. In some embodiments, wall 124 may enclose backside 122 of pump 118, for example for basins to be used with battery operated pumps. In other embodiments, for example as shown in FIG. 4, wherein an electric pump 118 is used, a channel 126 extends from wall 124 of cutout 116 to the edge of basin 100 allowing an electric cable to run from pump 118 over rim 128 of the basin 100 to an electric outlet without interfering with the stability of the container. Optionally, a drain may be provided in the bottom surface of basin 100.

As shown in FIGS. 4-6, the contours of basin 100 have a shape similar to a D when viewed from the top. The D-shaped basin is formed by chamber 102 having a generally rectangular shape and platform 104 having a semicircular shape. In other embodiments, the basin may have a different shape. For example, the chamber may be configured to have a square, semicircular, or any other suitable shape.

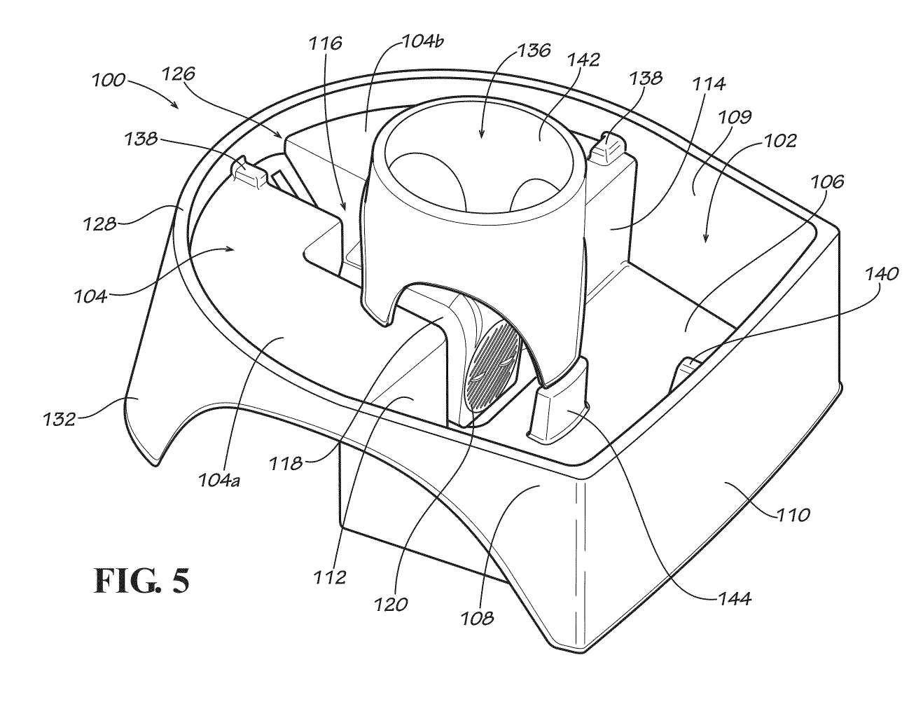

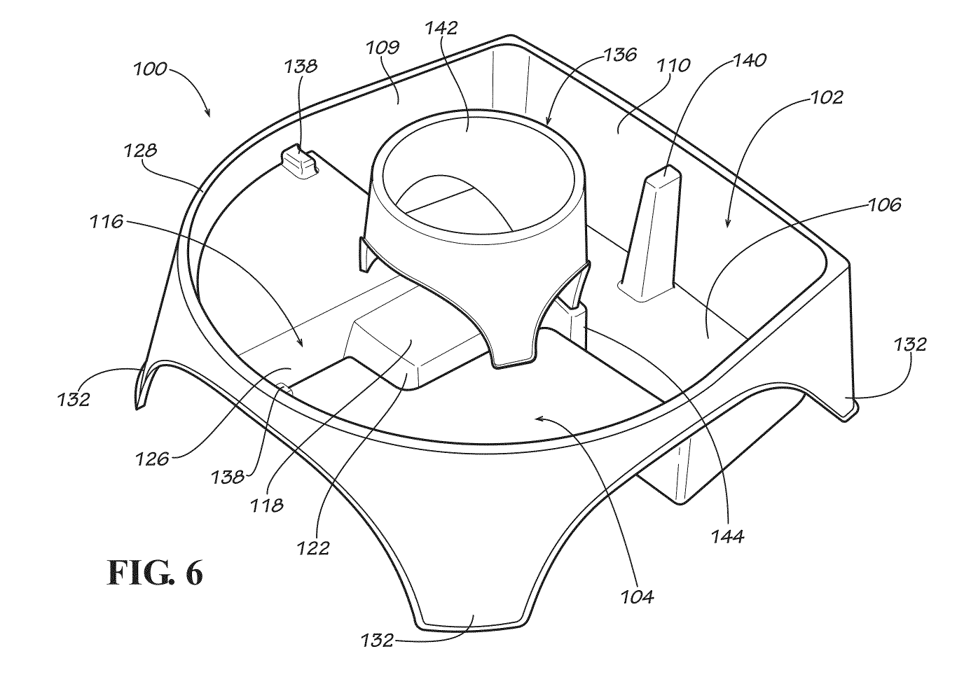

FIGS. 4-6 show a basin 100 with double walled sides. Outer walls of basin 100 may extend outwardly down from rim 128 to form support structures for the basin, for example, support legs 132 and front wall 110 may provide a sturdy base on a horizontal work surface. In some embodiments, outer walls 128 may be configured to interact with a work surface, such as a sink for example. Basin 100 further has one or more footprints of support elements to hold different sizes of containers upside down with the opening above the cleaning solution. One footprint may be concentric with another footprint. A first diameter of the footprint may be formed by the outer perimeter of the basin, for example as indicated by rim 128. This area defines a first diameter of a container that the basin is capable of supporting. Within the perimeter of the rim and concentric within the first footprint may be a second footprint of additional support elements that define diameters of smaller sized containers. These footprints may be concentric around pump outlet channel 146. In some embodiments, protrusions 138 may extend radially from the rim 128 towards the inside of the basin. In other embodiments, protrusions 138 allow positioning of a container on the platform so that the edge of the container is held by protrusions 138 with the nozzle in the center and supported by the platform and/or protrusions. Optionally, the inside of front wall 110 along chamber 102 may have protrusions to support a container, for example, a protrusion 140 extending from the side below rim 128, as shown in FIGS. 5-6. In some embodiments, support elements may have stepped portions or otherwise incrementally decreasing/increasing portions to accommodate different sizes of containers. In other embodiments, support elements may have slanted or gradually decreasing/increasing surfaces to hold different sizes of containers.

FIGS. 5-6 show another embodiment of a basin 100 wherein a first footprint defines an area for holding different sizes of larger containers with straight sides, for example of a bucket type, and a second footprint, defined a support assembly 136 mounted within the perimeter of the first assembly, provides support areas for holding containers of the bottle type. For example, a second footprint for holding containers may be provided by a support assembly formed by a removable support rack 142 that is positioned in the center of basin 100, as shown in FIGS. 4-5. Support rack 142 is adapted to hold, a bottle type container upside down by supporting the shoulders of the bottle and holding the mouth of the bottle above the cleaning solution. The rack may be configured to support different sizes of bottles. For example, support elements similarly as those described above may be provided along the inside of a cone-shaped rack. In other embodiments, the rack may have slanted or stepped surfaces to hold the shoulders and mouth of a bottle. In the embodiment shown, rack 142 has three legs, two of which rest on platform 104 and one resting on a base 144 in chamber 102. In other embodiments, rack 142 may have different configurations, such as four legs. Optionally, a rack may be integrated with the basin. In the embodiments shown, rack 142 is a distinct element separate from basin 100. However, in other embodiments, rack 142 may be integrated with basin 100 to form a one-piece structure. In the embodiments shown in FIGS. 4-6, pump 118 is a submersible type pump. These pumps have a hermetically sealed motor close-coupled to the pump body. The whole assembly is submerged in the fluid to be pumped. Examples of submersible pumps that may be are suitable for these embodiments are pumps such as commonly used in applications for drainage, sewage pumping, general industrial pumping and slurry pumping. One example of a suitable pump is aquarium pump such as the fountain pump offered for sale by Danner Manufacturing, Islandia, N.Y.

Pump outlet channel 146 may be coupled to a channel extending into the container, such as tube 40 ending with nozzle 11 shown in FIGS. 1-3. This tube may be coupled to pump outlet channel 146 by, for example, by a snap fit coupling or threaded fasteners or any other suitable coupling means and extend vertically into the container.

The inventive subject matter further contemplates a method for cleaning of home brewing equipment by using the systems described above. For example, the following steps may be used in the cleaning process. First, a pump is installed in the basin. Then, cleaning solution is added to the chamber of the basin up to a level so that the pump inlet is submerged. Subsequently, a channel or tube is coupled to the pump outlet and a container is positioned on the basin so that the tube extends in the container. The pump may be activated by a switch or by plugging directly into an electric outlet. When the pump is activated, solution is pumped from chamber 102 into the channel so that the nozzle at the end of the channel releases pressurized solution against the inner walls of the container. The solution drains back into the basin thereby cleaning the inner walls of the container. Any cleaning solution on the platform drains into the chamber. The solution may be scooped out of the chamber, for example by a small cup and/or cleaning solution may be added to the chamber. After use and disassembly, the basin may be emptied and dried. The method for cleaning equipment may be repeated, for example for cleaning a container of a different size.

A basin according to the inventive subject matter may be made a material that is highly chemically resistant and stain-proof, for example a food-grade plastic material. The basin may be made by suitable molding techniques, such as injection molding, compression molding, thermoforming, etc.

In the embodiments shown in FIGS. 4-6, the dimensions of the basin are approximately 15.5″ by 15.5″ at the base and the sides are approximately 12″ high. Support rack 142 is approximately 5″ in diameter and 4″ high. The nozzle protrudes approximately 8″ beyond the upper rim of the support rack. These dimensions are for illustrative purposes only and the dimensions and overall size of the apparatus may vary.

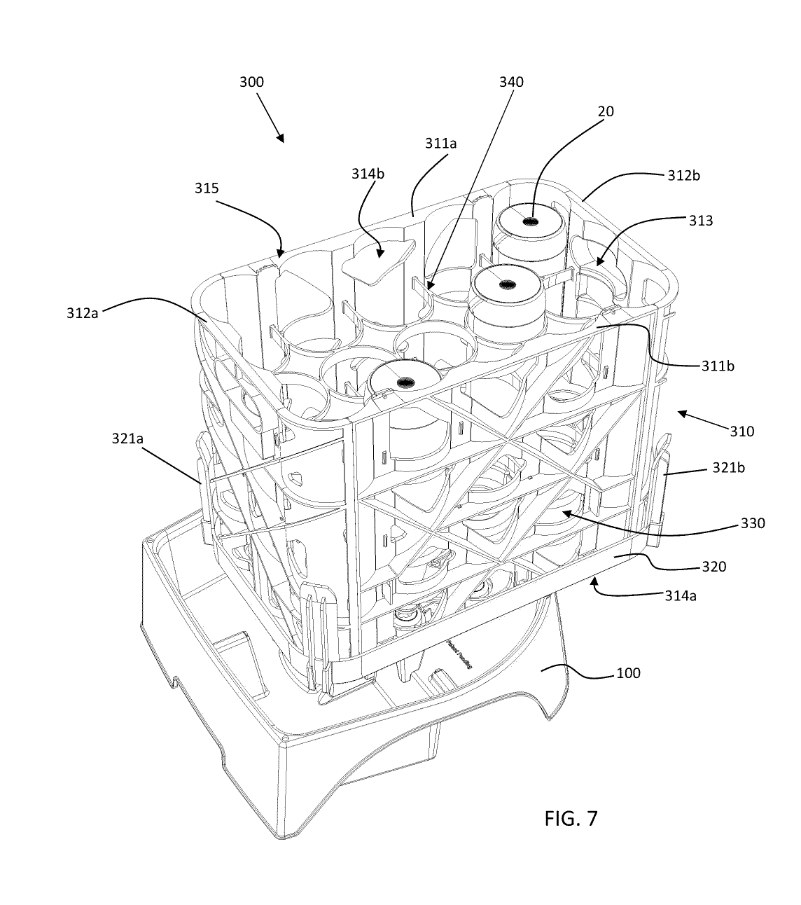

FIG. 7 shows an example of a bottle management system 300. Although many other variations of bottle management systems will become apparent to artisans of ordinary skill following a review of the present disclosure, bottle management systems configured to accommodate fifteen 22-ounce bottles will be described by way of example. It is contemplated that bottle management systems configured to accommodate fifteen or thirty 22-ounce bottles could be particularly desirable as 5-gallon batches of beer are commonly brewed by home brewers, and thirty 22-ounce bottles can accommodate 5 gallons of liquid (e.g., one 5-gallon batch of beer). Nonetheless, bottle management systems configured to accommodate other numbers and sizes of containers can adopt one or more of the innovative principles disclosed herein without departing from the scope and the spirit of the present disclosure.

The exemplary bottle management system 300 shown in FIG. 7 includes a basin 10, 100 and a pump 13, 118 of the type described above for example, in connection with FIGS. 4-6. The bottle management system 300 shown in FIG. 7 also includes a carriage frame 310 sized to accommodate a plurality of containers 20 and an adapter 320 configured to matingly engage with the basin 100 and with the carriage frame 310 so as to operatively support the carriage frame 310 above the basin 100.

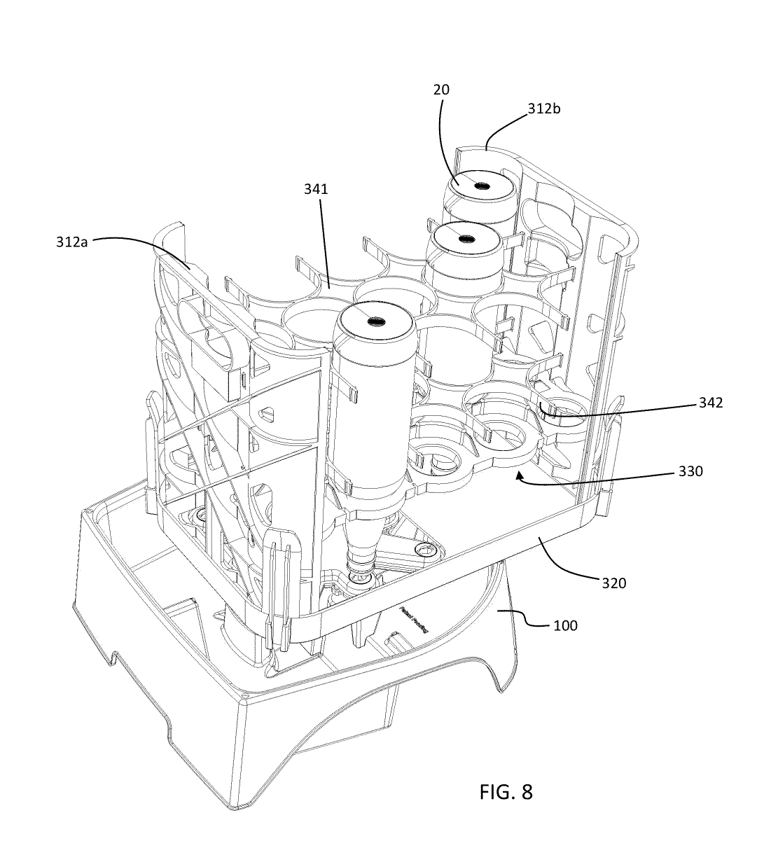

As shown in FIGS. 7 and 8, a retainer 330 can be positioned in the carriage frame 310 and be configured to support the plurality of containers 20 in an inverted orientation or in an upright orientation (not shown) (e.g., by resisting a gravitational force applied to each of the containers). In FIGS. 7 and 8, the retainer 330 supports a plurality of containers 20 in an inverted orientation. As also shown in FIG. 7, one or more receivers 340 can be positioned in the carriage frame 310 and be configured to maintain a selected degree of separation between adjacent containers 20 supported by the retainer 330.

In particular, but not exclusively, a carriage frame 310 can accommodate fifteen 22-ounce bottles in an upright orientation and in an inverted orientation. For example, fifteen empty 22-ounce bottles can be placed in the carriage frame 310 in an inverted orientation for cleaning or for storage (shown in FIG. 7). Alternatively, fifteen full 22-ounce bottles can be placed in the carriage frame 310 in an upright orientation (not shown) for storage of the filled vessels (e.g., during fermentation and afterward, until the contents are consumed).

As shown by a comparison of FIGS. 7 and 8, a carriage frame 310 can have opposed side walls 311a, b (shown in FIG. 7 and removed in FIG. 8) spaced apart from each other and opposed end walls 312a,b (shown in FIG. 8) spaced apart from each other. Such a carriage frame 310 can define an interior region 313 having a first open face (e.g., a lower face 314a) and an opposed open second face (e.g., an upper face 314b). Such a carriage frame 310 can define a boundary of the interior region 313 extending between the opposed first and second open faces 314a,b.

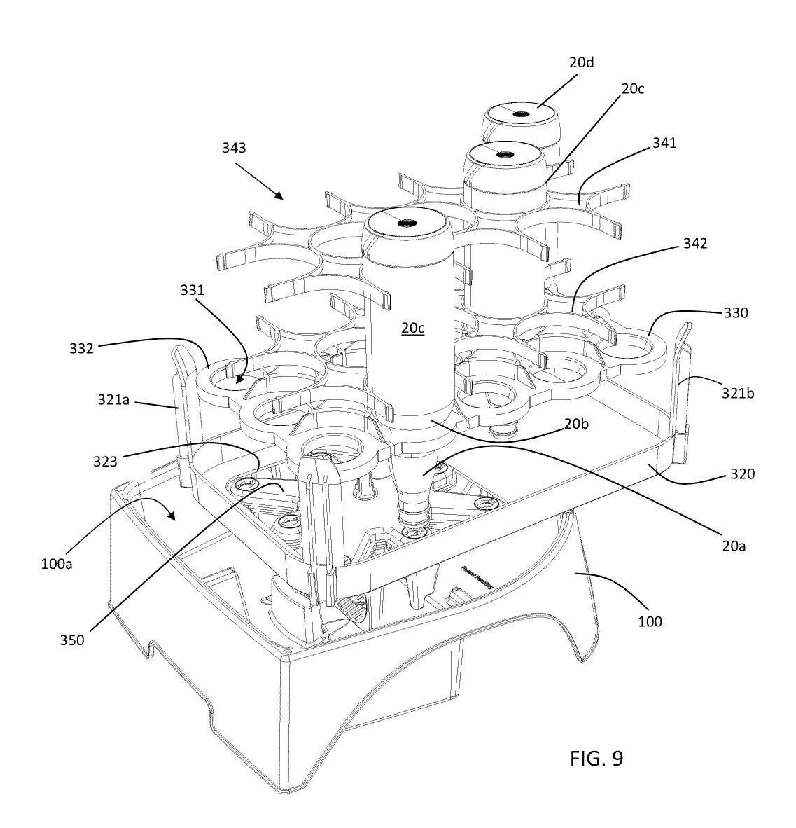

In FIG. 9, the opposed end walls 312a,b of the carriage frame are removed to reveal a retainer 330 positioned within the carriage frame 310 shown in FIGS. 7 and 8. The illustrated retainer 330 extends generally transversely relative to the interior region 313 defined by the carriage frame 310 shown in FIG. 7.

Retainers 330 as shown in FIGS. 7 through 9 can be configured to support one or more upright containers 20 and/or one or more inverted containers 20. For example, the illustrated retainer 330 defines a plurality of apertures 331. Each of the illustrated apertures 331 is sized so as to receive a neck 20a of a bottle (e.g., an inverted bottle). When received by the retainer 330, the neck 20a of the bottle 20 extends through the retainer 330 and a shoulder 20b defined by the bottle urges against the retainer 330, and thereby prevents a body 20c of the bottle from passing through the retainer.

The retainer 330 can also define a bearing surface 332 positioned outwardly of each of the plurality of apertures 331. For example, the retainer 330 can define an upper surface and a plurality of, for example, circular recesses 333. Each recess 333 can be sized to receive a corresponding bottle (e.g., a base 202 of a body of a bottle). Each of the plurality of apertures 331 can extend through a central region of a corresponding circular recess 333 defining, for example, an annular bearing surface 332 configured to support a bottle 20 in an inverted or in an upright orientation. Moreover, each of the plurality of apertures 331 and recesses 333 can be suitably spaced apart from each adjacent aperture and recess to permit a plurality of inverted (or upright) bottles 20 to be supported by the retainer 330.

In some embodiments, the retainer 330 can be movably coupled to the carriage frame 310 in one or more retainer positions. As an example, the retainer 330 in the bottle management system 300 shown in FIG. 7 is configured to movably couple to the carriage frame 310 in a first (e.g., a relatively lower) retainer position and in a second (e.g., a relatively higher) retainer position. In FIG. 7, the retainer 330 is positioned in a relatively higher position to accommodate the inverted bottles 20. For example, the first retainer position can be positioned between the second open face 314b of the interior region 313 of the carriage frame 310 and the second (lower) retainer position (not shown).

In some embodiments, the retainer 330 is configured to matingly engage with the carriage frame 310 in one or more retainer positions. For example, the retainer can matingly engage with the carriage frame 310 in one or both of the first retainer position and the second retainer position. In an alternative embodiment, the retainer 330 can be configured to slidingly couple with the carriage frame 310.

Some carriage frame 310 embodiments have one or more position limiters configured to inhibit an extent of movement of the retainer 330 outwardly of the first retainer position and the second retainer position. For example, the carriage frame 310 can define spaced apart bosses (not shown) extending inwardly of the carriage frame 310 into the interior region 313 to act as “stops” to inhibit or prevent the retainer 330 from being positioned outwardly of the first retainer position or the second retainer position.

Carriage frames 310 of the type shown in FIG. 7 can be so dimensioned, and the first retainer position can be so spaced from the second open face 314b, as to permit a selected upright container 20 (e.g., a 22-ounce bottle) to fit entirely within the interior region 313 defined by the carriage frame 310 between the retainer 330 and the second open face 314b. Such carriage frames 310 can be used to store filled containers 20 (e.g., filled and capped bottles of home-brewed beer).

In addition, or alternatively, carriage frames 310 of the type shown in FIG. 7 can be so dimensioned, and the second retainer position can be so spaced from the first open face 314a and from the second open face 314b, as to permit a selected inverted container 20 to fit entirely between the first open face 314a and the second open face 314b within the interior region 313 defined by the carriage frame 310. For example, in the second retainer position, the retainer 330 can support an inverted bottle 20 within the interior region 313, as shown for example in FIGS. 7 through 9. As FIG. 9 shows, a neck 20a of an inverted bottle can extend through an aperture 331 in the retainer and a shoulder 20b of the inverted bottle can urge against the retainer 330, thereby supporting the inverted bottle.

As noted above, home brewers often brew beverages in five-gallon batches, and thirty 22-ounce bottles can accommodate five gallons of liquid. As explained above, some carriage frames 310 are configured to accommodate fifteen 22-ounce bottles, or about half of the volume of commonly brewed batch of a beverage.

Some carriage frames 310 define an upper bearing surface 315 and a lower bearing surface (not shown) suitable for stacking with one or more other carriage frames. For example, an upper surface 315 of a carriage frame 310 can define one or more features having a configuration complementary to one or more other features defined by a lower surface of the carriage frame. Such a complementary configuration between an upper and a lower surface of a carriage frame 310 can permit the carriage frame to matingly engage with another, identically (or similarly) configured carriage frame, allowing two or more identically (or similarly) configured carriage frames to be stacked together in a mating engagement. Thus, an entire 5-gallon batch of a brewed beverage can be accommodated in two carriage frames 310.

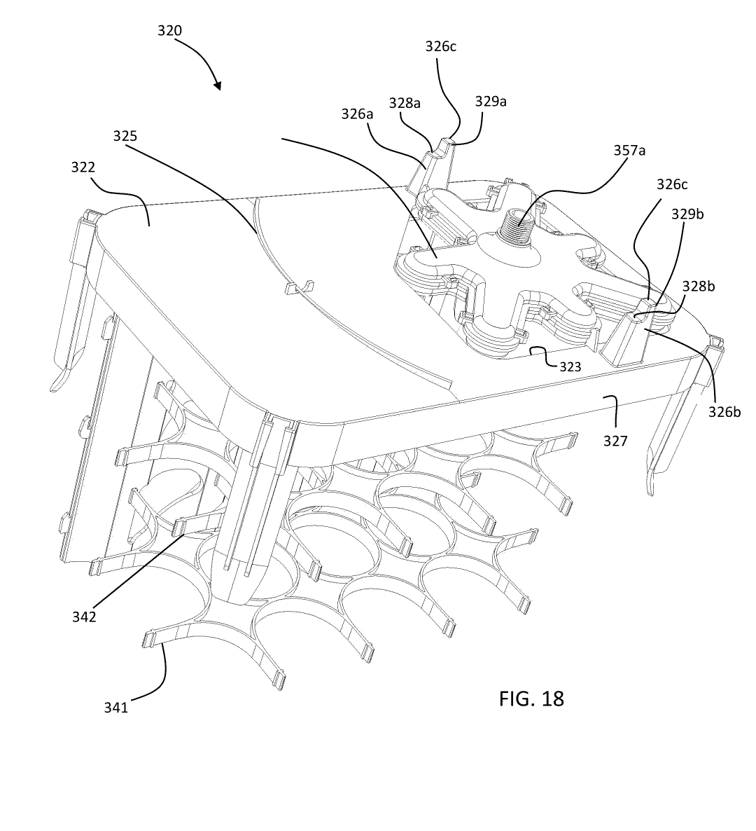

The bottle management system 300 shown in FIG. 7 also includes an adapter 320. The adapter 320 can be configured to matingly engage with the carriage frame 310 and to operatively support the carriage frame 310 above a selected basin 18, 100. For example, an upper surface (e.g., FIG. 7) of an adapter 320 can have one or more features (e.g., guide rails 321a,b) configured to matingly engage with or to receive a carriage frame 310 as described above. A lower surface 322 (e.g., FIGS. 7 and 18) of the adapter 320 can have one or more features configured to matingly engage with or to urge against corresponding or complementarily configured portions of a basin 18, 100.

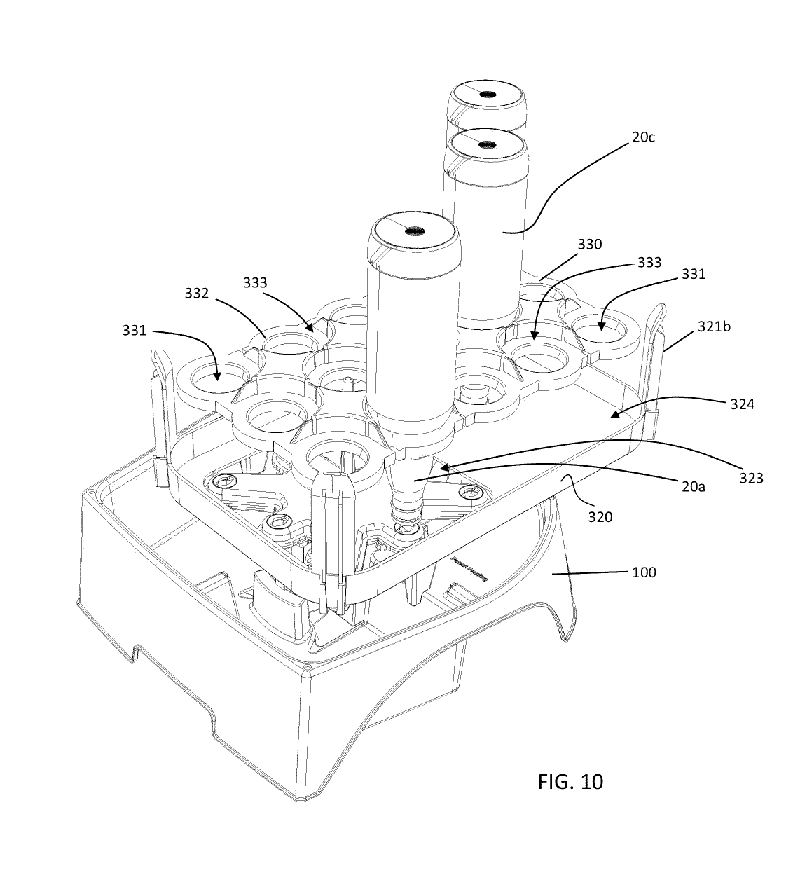

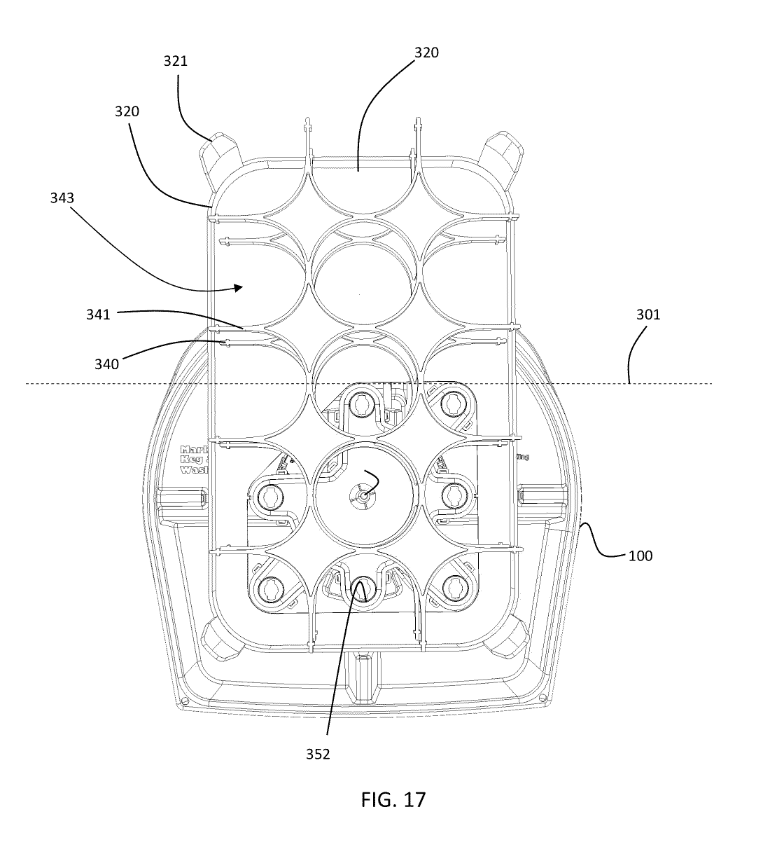

As shown in FIGS. 10 through 12, an adapter 320 can define an aperture 323 having a perimeter. The aperture 323 can be configured to correspond to a one or more aspects of the retainer 330. For example, the aperture 323 can be configured such that a projection of at least two of the plurality of retainer apertures 331 lies at least partially within the aperture 323 defined by the adapter 320, as indicated by the plan view shown in FIG. 17.

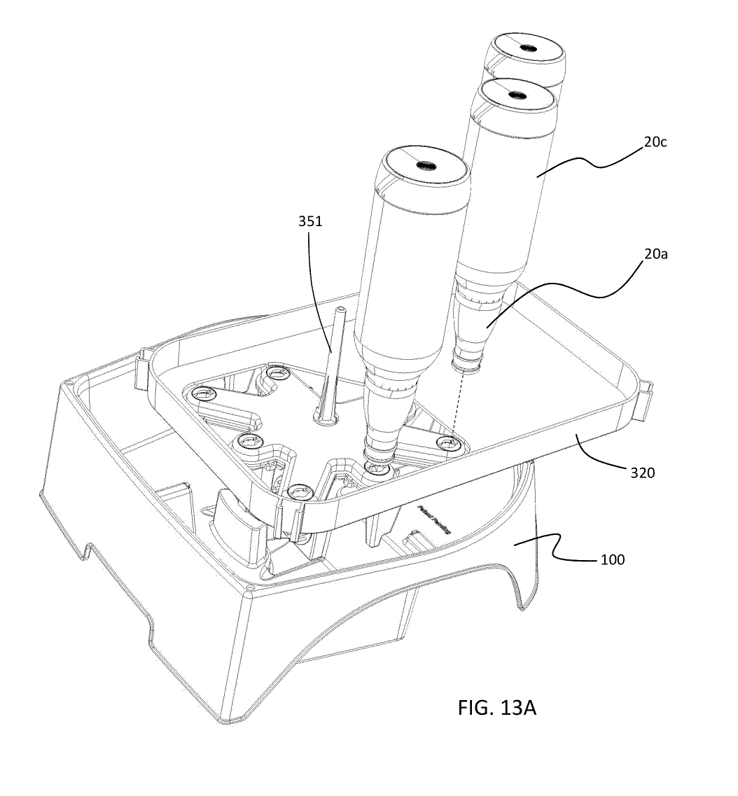

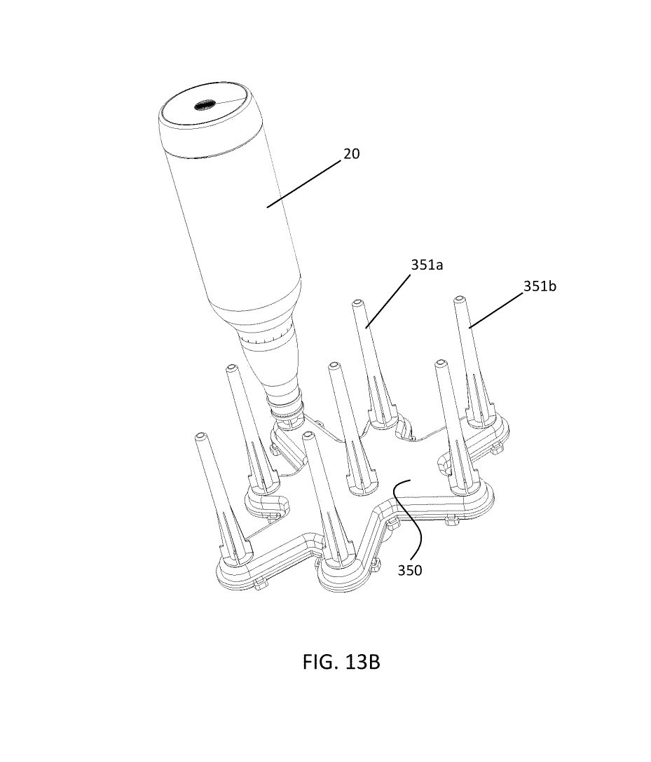

As shown in FIGS. 10 through 13, a bottle management system 300 can include a selected number of nozzles 351. One or more of the nozzles 351 can extend through the aperture 323 defined by the adapter 320. In some bottle management systems, the selected number of nozzles 350 at least partially corresponds to the number of retainer apertures 331 (e.g., the capacity of the corresponding carriage frame 310), as each nozzle 351 can be configured to deliver a jet of a wash solution to a corresponding inverted bottle 20 positioned over the nozzle 351, as indicated by the view of the assembly shown in FIG. 13. As well, a position of each of the selected number of nozzles 351 can correspond to a position of one or more of the retainer apertures 331 (e.g., as the position of each bottle 20 to be washed can correspond to a position of an aperture 331 in the retainer 330).

In the bottle management system 300 shown in FIG. 7, et seq., the aperture 323 in the adapter 320 is sized to permit eight nozzles 351 to extend therethrough. Stated differently, the number of nozzles 351 selected for the illustrated bottle management system 300 is a selected integer greater than 50% of the number of bottles 20 that can be accommodated by the carriage frame 310 and retainer 330. With such a bottle management system, a full carriage frame 310 having at least one plane of symmetry 301 and containing plural (e.g., fifteen) inverted bottles 20 can be positioned in a first position to wash 50% or more of the bottles it contains and reoriented (e.g., rotated by 180 degrees) to wash the remaining (e.g., 50% or more of the) bottles it contains.

With regard to the particular example shown in FIG. 7, et seq., the eight nozzles 351 can wash eight of fifteen bottles within the carriage frame 310. Subsequently, the carriage frame 310 can be rotated by 180 degrees to place the remaining seven (e.g., unwashed) bottles and one previously washed bottle over the eight nozzles 351. The remaining seven bottles can be washed and the one previously washed bottle can be re-washed.

Naturally, other bottle management system configurations are possible. For example, the aperture 323 in the adapter 320 can be configured to receive, e.g., fifteen nozzles 351. Such a configuration could permit washing all fifteen bottles 20 in the carriage frame 310 without repositioning the carriage frame 310. However, a bottle management system 300 having eight nozzles 351 is presently believed to be compatible with a greater number of keg and carboy wash systems presently in use by prospective customers of disclosed bottle management systems 300 than a bottle management system having fifteen nozzles. For example, a larger pump 13, 118 could be preferred for delivering a sufficient volumetric flow rate of a wash solution to fifteen nozzles as compared to a a pump suitable for delivered a desired volumetric flow rate of a wash solution to eight nozzles.

The illustrated bottle management system 300 includes a distribution manifold 350 configured to distribute a liquid (e.g., a wash solution) among the selected number of nozzles 351. A pump 13, 118 can be fluidly coupled to the distribution manifold 350 such that the distribution manifold is configured to distribute a liquid discharged from the pump among the selected number of nozzles 351. In some instances, the pump can be a submersible pump positioned within a reservoir 100a (sometimes also referred to as a “basin”) containing a wash solution.

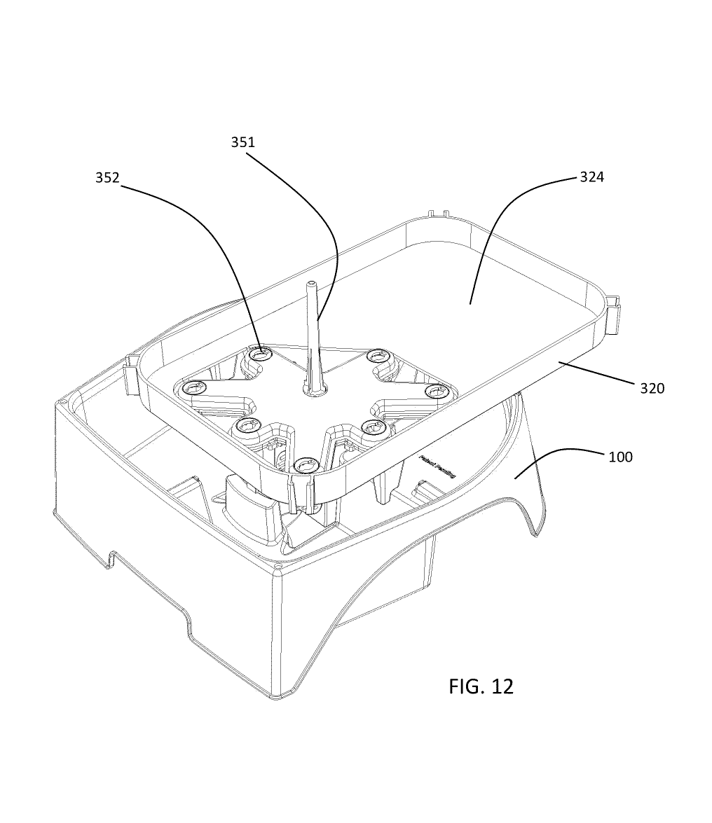

In some embodiments, e.g., as shown in FIGS. 12 and 13, the adapter 320 can include a drain pan 324. As shown in FIG. 13, when the adapter 320 is operatively positioned above the reservoir 100a, the drain pan 324 can direct a liquid, e.g., residual wash solution drained from an inverted bottle 20, through the aperture 323 and into the reservoir 100a. Such a drain pan 324 can be particularly desirable for returning wash solution to the reservoir 100a after washing fewer than all of the bottles contained in the carriage frame 310.

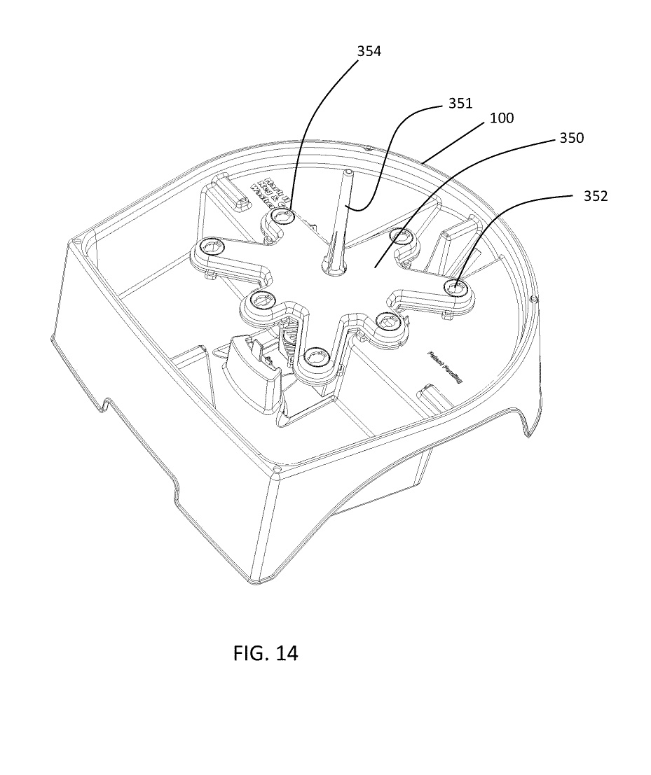

FIG. 14 shows a distribution manifold 350 defining a plurality of outlet ports 352 configured to matingly receive a corresponding plurality of nozzles 351 configured to inject a stream of a wash solution into a corresponding plurality of inverted bottles (not shown). An O-ring 354 or other sealing member can be positioned in an interstitial region between a nozzle body 351a and a portion of the manifold body circumscribing an outlet port. In FIG. 14, one nozzle 351 is positioned in a mating engagement with a respective one of the outlet ports 352 and the remaining outlet ports 352 are shown without a corresponding nozzle.

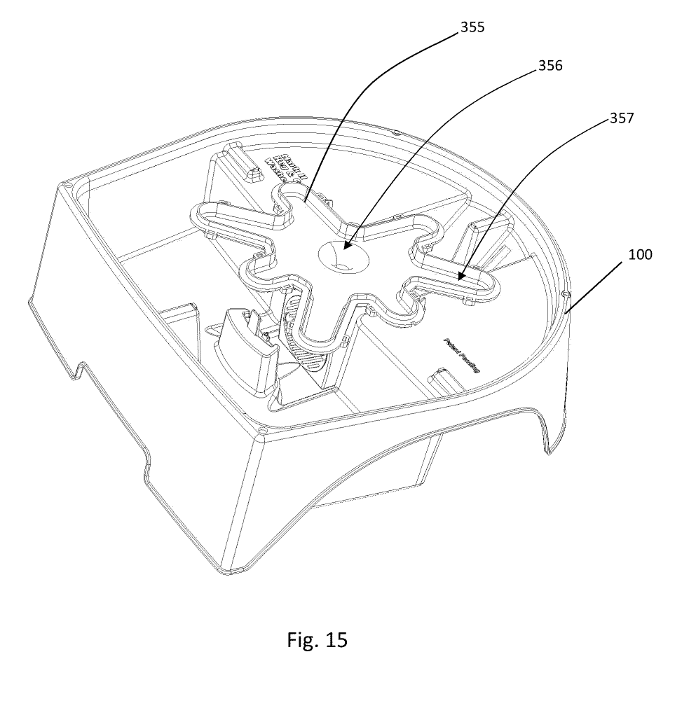

FIG. 15 shows an upper panel of the distribution manifold 350 removed to reveal a lower panel 355 of the distribution manifold 350 defining a manifold inlet 356 configured to fluidly couple to an outlet of a pump. A gasket or other sealing member can be positioned in an interstitial region between a surface of the lower panel 355 circumscribing the manifold body and a corresponding surface of the upper panel circumscribing the upper panel of the manifold body. As shown in FIG. 14, the upper panel of the distribution manifold defines the plurality of outlet ports 352. An open inner volume of the distribution manifold defines a plenum region surrounding the inlet 356 and a plurality of outwardly (e.g., radially) extending manifold branches 357. Each of the plurality of radially outwardly extending manifold branches 357 corresponds to a respective one of the outlet port 352/nozzle 351 assemblies.

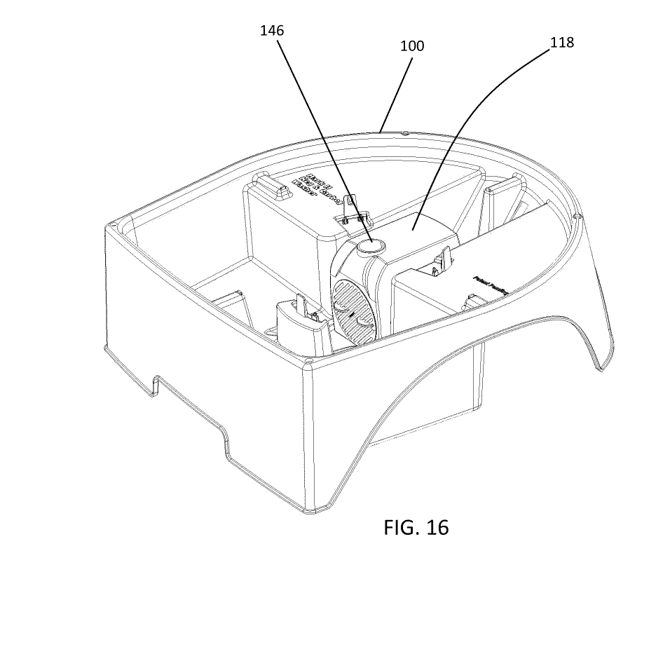

FIG. 16 shows an isometric view of the basin 100 and pump 118 assembly depicted in FIG. 4.

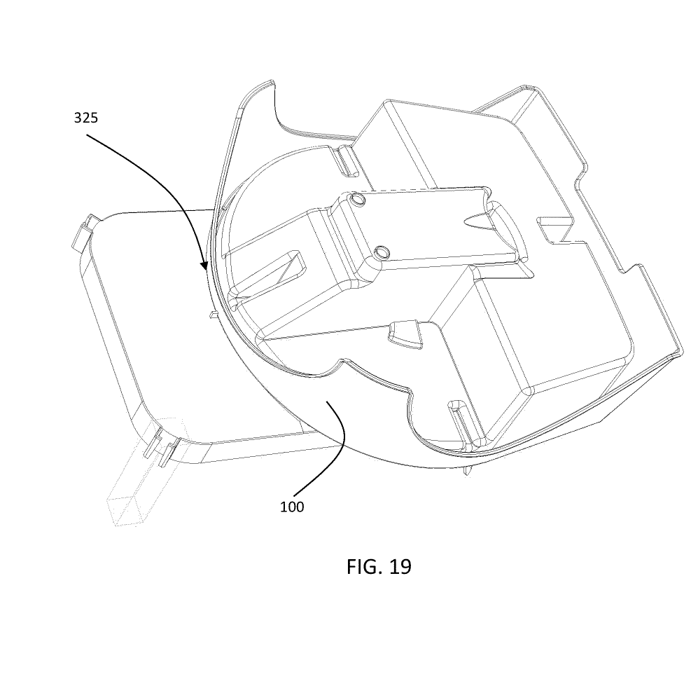

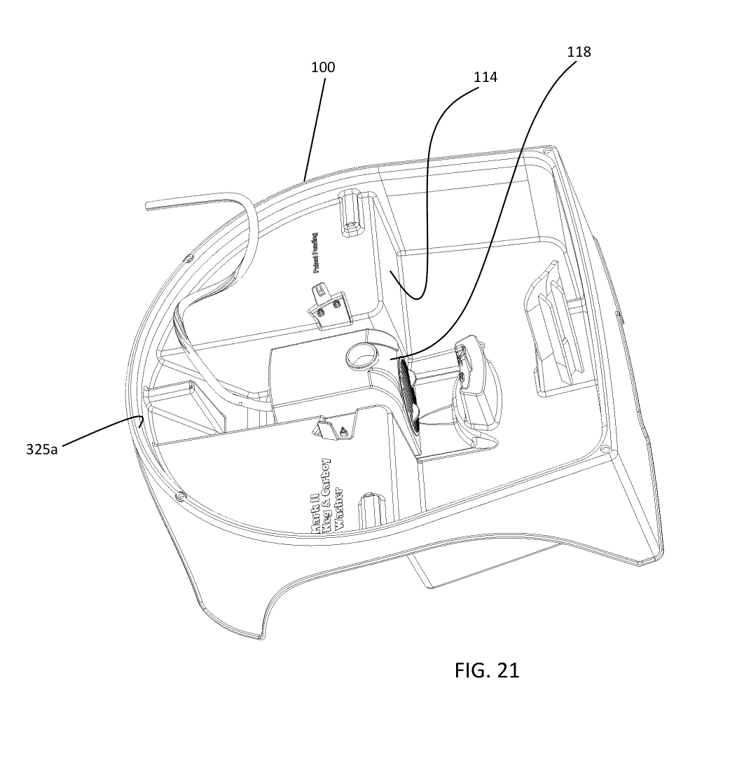

FIG. 18 shows an isometric view from below the distribution manifold 350, adapter 320 and two receivers 341, 342 corresponding to a bottle management system of the type disclosed herein. The lower face 322 of the adapter 320 defines an arcuate ridge 325 extending transversely across the adapter. As shown in FIG. 19, the arcuate ridge 325 has a complementary configuration in relation to an arcuate portion 325a of the basin 100 (e.g., shown in FIG. 21).

Additionally, FIG. 18 shows opposed legs 326a,b extending from the lower face 322 of the adapter 320. The opposed legs 326a,b are positioned outwardly of the aperture 323 and adjacent an outer perimeter 327 of the adapter 320. Each of the opposed legs 226a,b defines a ledge 328a,b, or shoulder, together with a boss 329a,b extending between the ledge 328a,b and a distal end 326c of the leg 326a,b.

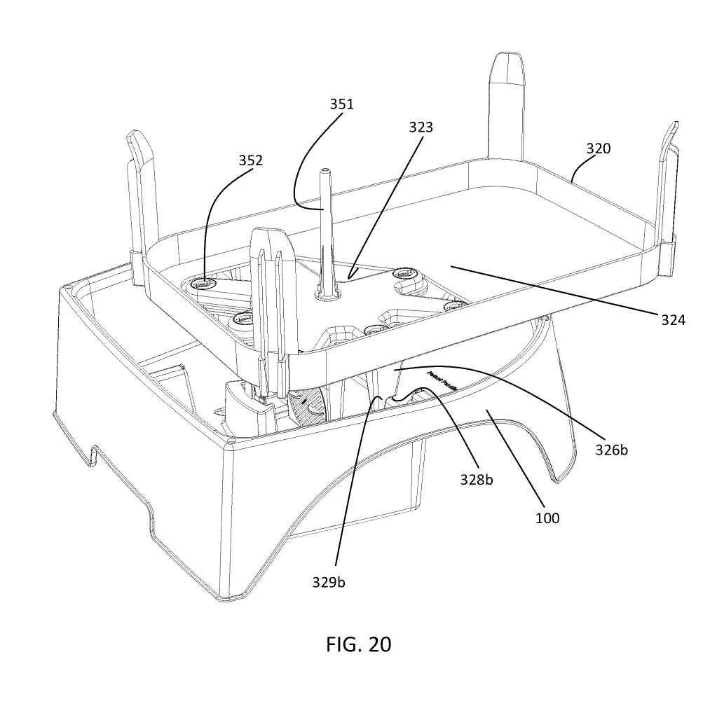

As shown in FIG. 20, the ledge 328a,b, or shoulder, of each leg 326a,b can rest on a portion of the basin 100 when the adapter 320 is received by the basin. The boss 329a,b extends downwardly along a generally vertical wall of the basin. Accordingly, the configuration of the opposed legs 326a,b, together with that of the arcuate ridge 325, can align the adapter 320 relative to the basin 100, as well as relative to the plurality of nozzles 351.

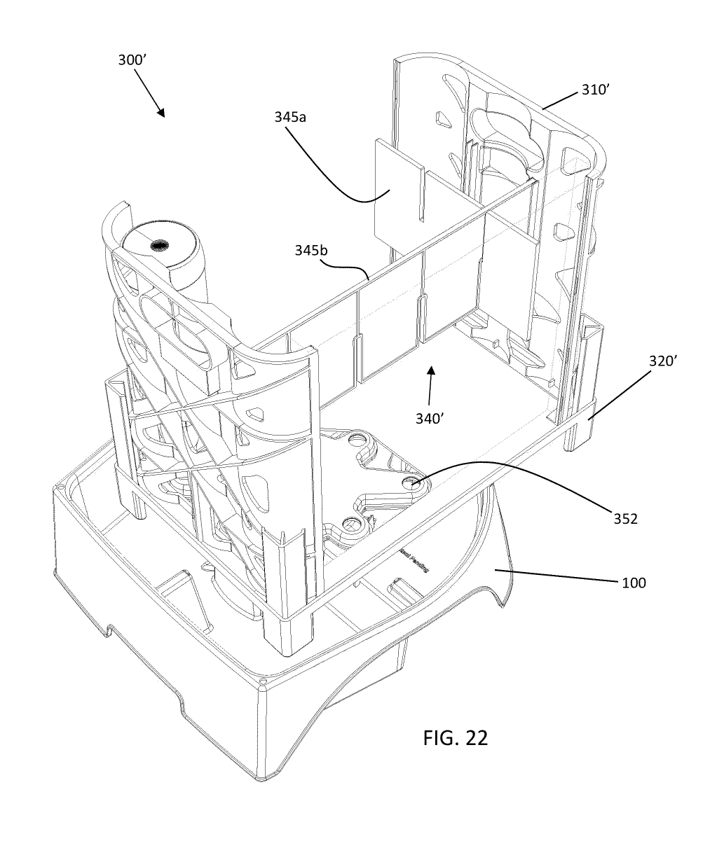

FIG. 22 shows a portion of an alternative embodiment of a bottle management system 300′. In the alternative embodiment, a plurality of vertically oriented and interlocking walls 345a,b defines a receiver assembly 340′ configured to maintain a selected spacing between adjacent bottles in the carriage frame 310′. In contrast, the bottle management system 300 shown in, for example, FIG. 9 has a pair of vertically spaced apart receivers 341, 342, each defining a plurality of apertures or other receiver portions configured to receive a portion of an inverted (or an upright) bottle 20 and thereby maintain a selected spacing between adjacent bottles.

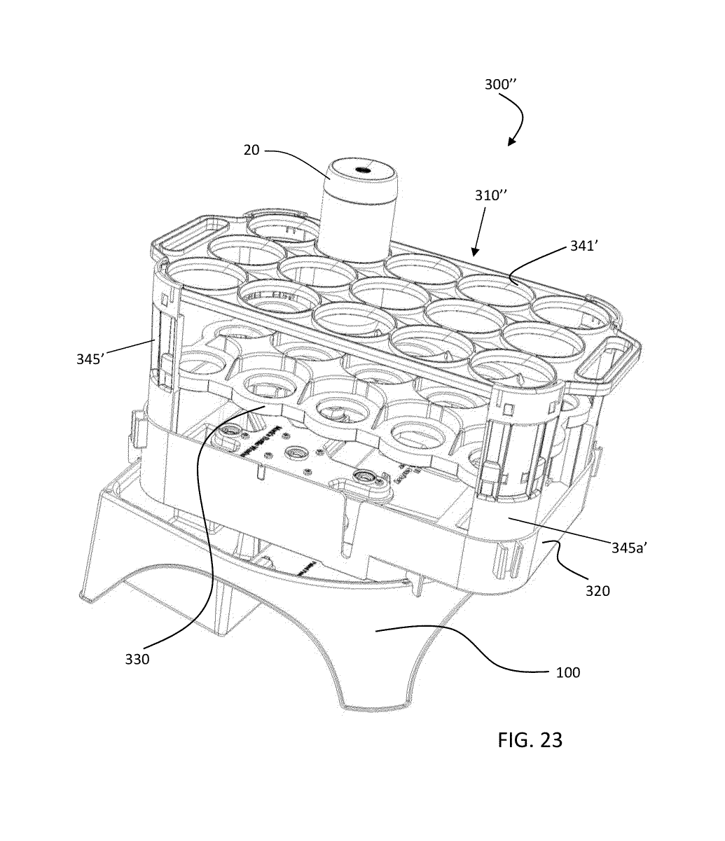

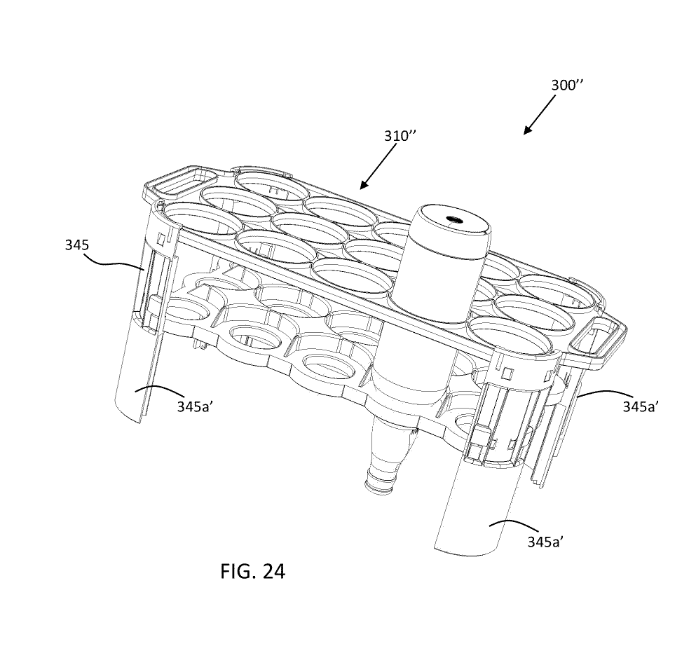

FIG. 23 shows an alternative embodiment of a bottle management system 300″. As shown in FIG. 23, a carriage frame can have a retainer and at least one receiver. In FIG. 23, the at least one receiver includes two receivers 341′, 342′ spaced apart from each other. An upper most receiver 341′ and the retainer 330 are positioned opposite each other relative to a lower receiver 342′ in FIG. 23. A plurality of legs 345′ extend between and couple the retainer 330 to the at least one receiver 341′. Each leg 345′ includes an extension 345a′ extending distally from the retainer 330. As described above, the retainer 330 can be movable relative to the legs 345, or can be immovable relative to the legs. As shown in FIG. 23, the legs 345′ can support the retainer 330 and the at least one receiver 341′ above the adapter 320. It should be noted that the legs 345′ shown in FIGS. 23 and 24 are illustrated schematically. Legs 345′ in a suitable working embodiment could include a rib, a gusset, a brace, or other structural feature to stiffen the legs (e.g., to prevent the legs from splaying outwardly, or from buckling). The legs 345′ can be configured to matingly engage with the adapter 320, or can be configured to rest on a suitable portion of the adapter. As with bottle management systems 300, 300′ described above, the alternative carriage frame 310″ shown in FIGS. 23 and 24 can be positioned above the adapter 320 and nozzles 351 to wash 50% or more of the bottles 20 in one wash cycle and rotated to wash the remaining bottles. Moreover, inverted, as well as upright, bottles can be stored in the carriage frame shown in FIGS. 23 and 24, just as with bottle management systems described above.

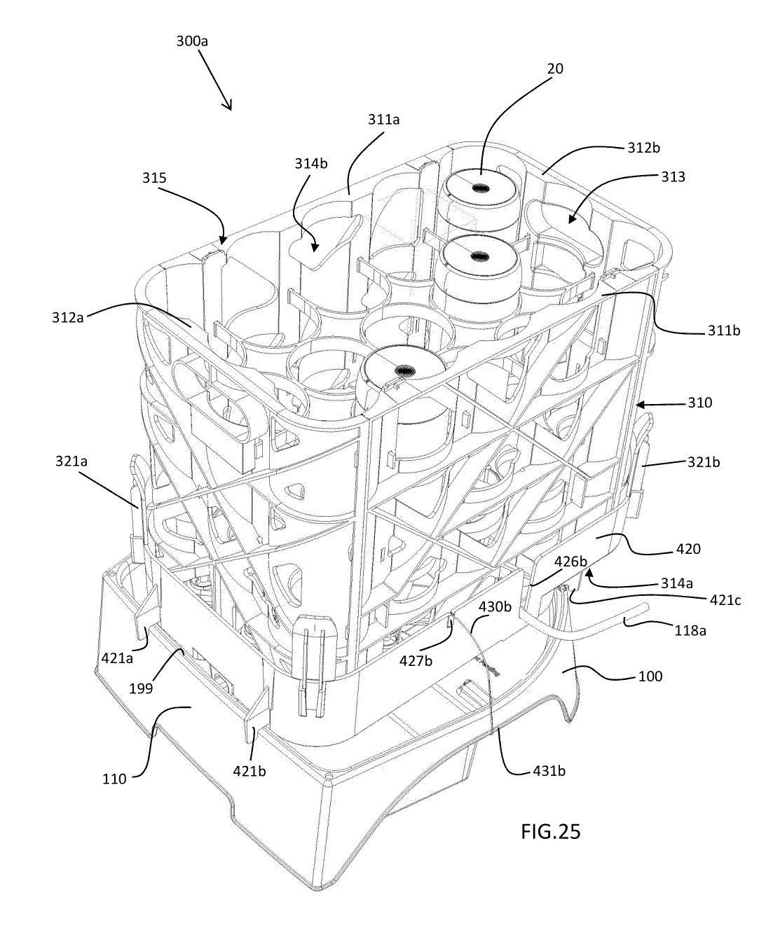

FIGS. 25, 26, 27 and 28 show aspects of another embodiment of a bottle management system 300a. In FIG. 25, the adapter 420 is arranged differently in certain respects than the adapter 320 described above. For example, the adapter 420 matingly engages the basin 100 in a position biased toward the outer sidewall 110 (shown in FIG. 4). The remaining components shown in FIG. 25 are arranged substantially similarly as described above, and in the interest of brevity, those components will not be described again.

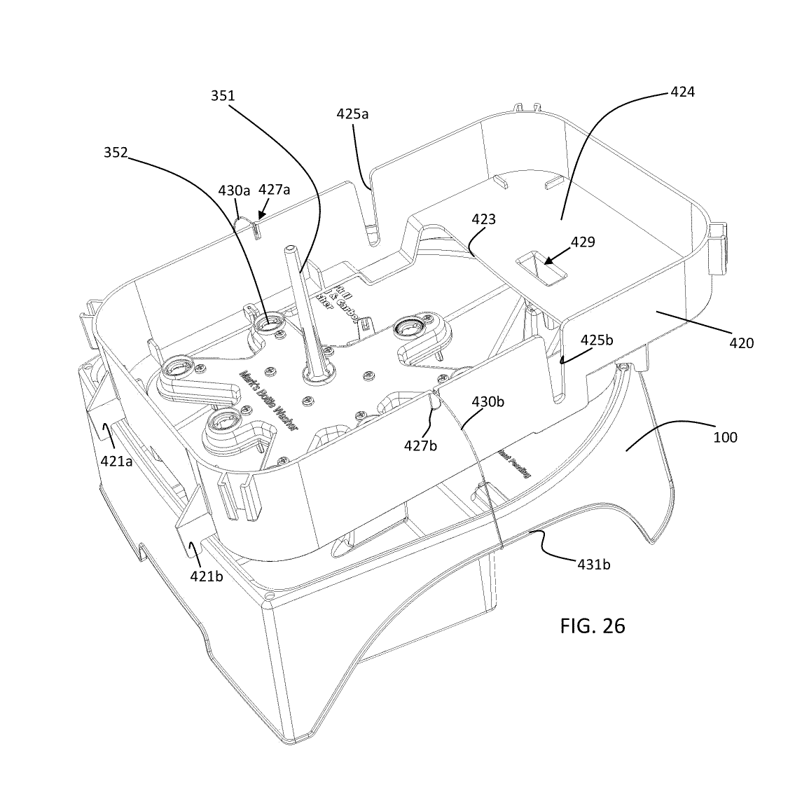

As shown in FIGS. 25 and 26, the adapter can define one or more outwardly extending tabs 421a, b arranged to rest on an upper edge 199 (or rim) of the basin 100. The tabs 421a, b define respective recessed regions arranged to receive the rim 199 such that a portion of the tabs 421a, b extend downwardly along the outer sidewall 110. The portions of the tabs 421a, b can urge against the outer sidewall 110 to inhibit the adapter from sliding out of the position shown in FIG. 25 and toward a position as shown in, for example, FIG. 7. The adapter can be inhibited from sliding out of the position shown in FIG. 25 in an opposite direction. For example, an outer wall of the adapter 420 positioned opposite the portions of the tabs 421a, b shown extending downwardly of the outer sidewall 110 can urge against an interior sidewall opposite the outer sidewall 110 to inhibit such repositioning.

In FIG. 26, opposed, recessed notches 425a, b are shown extending downward of an upper edge of an outerwall of the adapter 420. As shown in FIG. 25, the notches can receive an elongate member 118a extending from outside the basin 100 to a region adjacent to, or coextensive with, the reservoir 100a. Examples of an elongate member 118a include an electric cord of a pump 118, a tube for filing or replenishing cleaning solution, etc.

A biasing member 430a, b can extend between the adapter and the basin 100 to releasably couple the adapter 420 to the basin. For example, the adapter 420 can define a receiver 427a, b configured to providing a removable mating engagement between a first end of the corresponding biasing member 430a, b and the adapter 420. As shown, an interior portion of the receiver 427a, b can be outwardly recessed relative to the aperture 423 defined by the adapter 420. An opposite end of the biasing member can matingly engage with a lower edge 431b of the basin 100. The biasing member can have an elastically extensible body, and can urge the adapter 420 and the basin 100 together under an elastic force when the opposed ends of the biasing member 430a, b concurrently engage the upper edge of the adapter 420 and the lower edge 431 of the basin 100.

The aperture 423 defined by the adapter 420 differs from the aperture 323 described above, insofar as the aperture 423 is sized to receive a larger manifold than the aperture 323, allowing the bottle management system 300a to simultaneously wash a greater number of bottles 20, while still being compatible with 8-nozzle and 15-bottle arrangements described above.

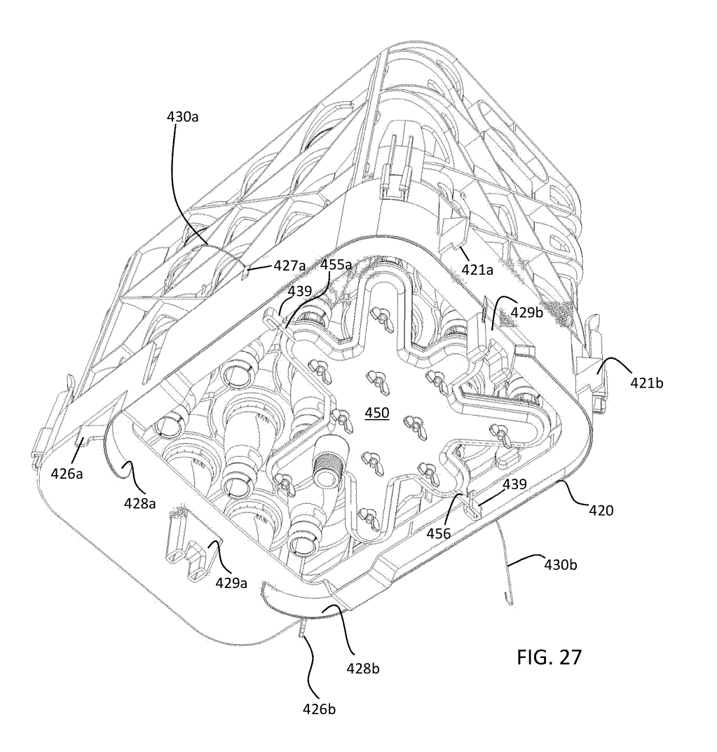

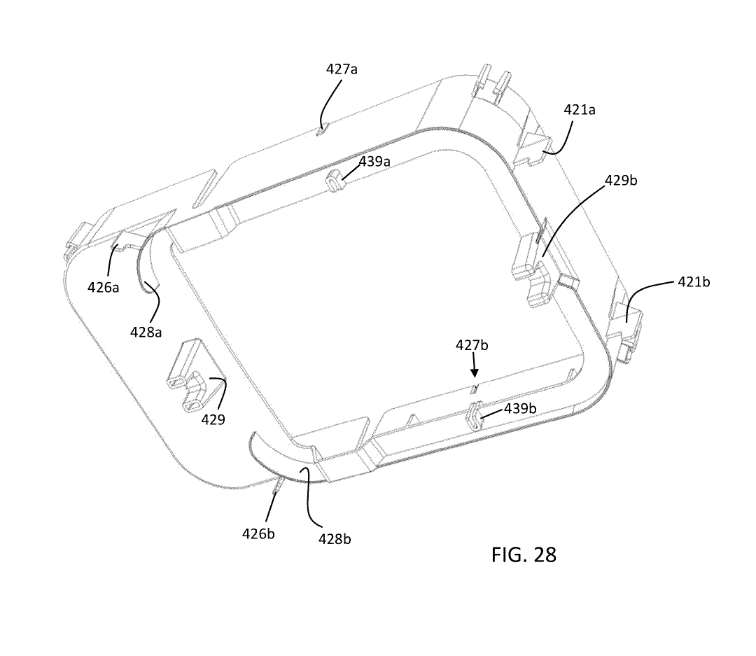

Referring now to FIGS. 27 and 28, features of an underside of the adapter 420 will be described. In addition to the tabs 421a, b described above, tabs 426a, b can extend downwardly of the adapter 420. As with the tabs 421a, b, the tabs 426a, b can define recessed regions arranged to rest on a portion of the basin's upper edge 199 extending beneath the adapter 420 when assembled as shown in FIG. 25. Arcuate members 428a, b can extend downwardly of the adapter 420 opposite the tabs 426a, b to capture the upper edge 199 of the basin 100 between the tabs 426a, b and the members 428a, b when the adapter 420 is assembled with the basin 100 as shown in FIG. 25. Legs 429a, b can also extend downwardly of the adapter 420 and be sized to rest on a corresponding horizontal (or substantially horizontal) surface of the basin when the adapter 420 and the basin 100 are assembled together as shown in FIG. 25.

As best shown in FIG. 26, a manifold 450 can define outwardly extending tabs 455a, b arranged to matingly engage with a recessed portion 439a, b (e.g., a slot) of the adapter 420. Such a mating engagement between the tabs 455a, b and the recessed portion 439a, b can align the manifold relative to the adapter 420. Such alignment of the manifold with the adapter can ensure that the manifold is aligned with the bottles 20 when the bottle management system 300a is assembled as shown in FIG. 25, providing a convenient arrangement for positioning a carriage frame full of inverted bottles over the basin 100 while ensuring that the nozzles 351 extend into the plurality of bottles.

The inventive subject matter further contemplates a kit including a basin, a support assembly, and a pressurizable channel. In some embodiments, the kit may also include a submersible pump.

The examples described above generally concern wash systems. Other embodiments than those described above in detail are contemplated based on the principles disclosed herein, together with any attendant changes in configurations of the respective apparatus described herein. Incorporating the principles disclosed herein, it is possible to provide a wide variety of convenient wash systems.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by references in its entirety for all purposes.

The principles (e.g., features) described above in connection with any particular example can be combined with the principles described in connection with another example described herein. Accordingly, this detailed description shall not be construed in a limiting sense, and following a review of this disclosure, those of ordinary skill in the art will appreciate the wide variety of filtering and computational techniques can be devised using the various concepts described herein. Moreover, those of ordinary skill in the art will appreciate that the exemplary embodiments disclosed herein can be adapted to various configurations and/or uses without departing from the disclosed principles.

The previous description of the disclosed embodiments is provided to enable any person skilled in the art to make or use the disclosed innovations. Various modifications to those embodiments will be readily apparent to those skilled in the art, and the generic principles defined herein may be applied to other embodiments without departing from the spirit or scope of this disclosure. Thus, the claimed inventions are not intended to be limited to the embodiments shown herein, but are to be accorded the full scope consistent with the language of the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the features described and claimed herein. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

Thus, in view of the many possible embodiments to which the disclosed principles can be applied, I reserve to the right to claim any and all combinations of features described herein, including but not limited to, for example, the combinations of features recited in the following claims and all that comes within the scope and spirit of the foregoing description.

All patent and non-patent literature cited herein is hereby incorporated by references in its entirety for all purposes.

1. A bottle management system, comprising:
a basin defining a reservoir for containing a liquid;
a retainer defining a plurality of apertures, wherein each of the apertures is sized to receive a neck of a bottle extending therethrough and to prevent a body of the bottle from extending therethrough such that the retainer is configured to support an inverted bottle when the neck of the bottle extends through the respective aperture, wherein each of the plurality of apertures is suitably spaced from each adjacent aperture to permit a corresponding plurality of inverted bottles to be supported by the retainer; and
an adapter configured to matingly engage with the basin at a position between the basin and the retainer, wherein the adapter defines an aperture and a projection of at least two of the plurality of retainer apertures lies at least partially within the aperture defined by the adapter.

2. A bottle management system according to claim 1, wherein the retainer further defines a respective bearing surface positioned outwardly of each of the plurality of apertures such that the retainer is further configured to support the corresponding plurality of inverted bottles in an upright orientation.

3. A bottle management system according to claim 1, wherein the at least two of the plurality of retainer apertures comprises at least eight retainer apertures.

4. A bottle management system according to claim 1, further comprising a selected number of nozzles, wherein the selected number of nozzles at least partially corresponds to the number of retainer apertures in the plurality of retainer apertures, wherein a position of each of the selected number of nozzles corresponds to a position of one or more of the retainer apertures.

5. A bottle management system according to claim 4, further comprising a distribution manifold configured to distribute a liquid among the selected number of nozzles.

6. A bottle management system according to claim 4, further comprising:
a distribution manifold fluidly coupled with each of the selected number of nozzles; and
a pump fluidly coupled to the distribution manifold such that the distribution manifold is configured to distribute a liquid discharged from the pump among the selected number of nozzles.

7. A bottle management system according to claim 4, wherein the selected number of nozzles comprises at least 50% of the number of retainer apertures in the plurality of retainer apertures.

8. A bottle management system according to claim 7, wherein the selected number of nozzles comprises 8 nozzles, and wherein the plurality of retainer apertures comprises 15 retainer apertures.

9. A bottle management system according to claim 4, wherein each of the selected number of nozzles is positioned to correspond with a selected one of the retainer apertures when the retainer is in a first position, and wherein each of all but one of the selected number of nozzles is positioned to correspond with a selected different one of the retainer apertures when the retainer is in a second position.

10. A bottle management system according to claim 1, further comprising a selected number of nozzles, each extending through the aperture of the adapter in alignment with a corresponding aperture in the retainer.

11. A bottle management system according to claim 1, wherein the adapter comprises a drain pan, wherein, when the adapter is matingly engaged with the reservoir, the drain pan is positioned between the retainer and the reservoir, and the aperture in the adapter is positioned above the reservoir such that the drain pan is configured to direct residual liquid through the aperture in the adapter and into the reservoir.

12. A bottle management system according to claim 1, further comprising a biasing member configured to urge the basin and the adapter toward each other.

13. A bottle management system according to claim 12, wherein an end of the biasing member matingly engages a corresponding portion of the adapter and an opposed end of the biasing member engages a portion of the basin.

14. A bottle management system according to claim 5, wherein the distribution manifold defines an alignment feature configured to mechanically couple the manifold with the adapter and thereby to maintain a selected position of the manifold relative to the apertures in the retainer.

15. A bottle management system according to claim 1, wherein the adapter defines a plurality of recessed regions configured to receive corresponding portions of the basin so as to inhibit relative motion as between the adapter and the basin.

16. A bottle management system according to claim 1, wherein an upper edge of the adapter defines a recessed notch configured to receive an elongate member extending therethrough.

17. A bottle management system, comprising:
a basin defining a reservoir for containing a liquid, the basin defining an upper edge;
a drip pan having a floor and a wall extending around a perimeter of the floor, and an interior opening extending through the floor, wherein the drip pan defines a plurality of engagement members urging against the upper edge of the basin so as to position the drip pan in relation to the basin;
a fluid distribution manifold having a plurality of nozzles extending through the interior opening of the drip pan, wherein each in the plurality of nozzles defines an opening configured to emit a jet of fluid in a direction away from the basin and the floor of the drip pan;
a retainer positioned above the drip pan and coupled with the basin to maintain a substantially constant position of the retainer relative to the basin and the nozzles, wherein the retainer defines a plurality of apertures spaced apart from each other in correspondence with a spacing among the nozzles.

18. A bottle management system according to claim 17, where the manifold defines a plurality of outwardly extending tabs, each being matingly engable with a corresponding recess defined by the drip pan.

19. A bottle management system according to claim 17, wherein a nozzle extends through more than half of the plurality of apertures defined by the retainer when the retainer is coupled with the basin.

20. A bottle management system according to claim 17, wherein the plurality of apertures defined by the retainer numbers 15 and the plurality of nozzles numbers 8.
